(19) United States
(12) Patent Application Publication
(10) Pub. No.: US 2017/0053268 A1
(43) Pub. Date: Feb. 23, 2017

(54) METHOD AND SYSTEM FOR IMPLEMENTING A WIRELESS DIGITAL WALLET

(71) Applicant: NUCLEUS SOFTWARE EXPORTS LIMITED, NEW DELHI (IN)

(72) Inventor: ASHUTOSH PANDE, NOIDA (IN)

(21) Appl. No.: 15/304,630

(22) PCT Filed: Apr. 15, 2015
(86) PCT No.: PCT/IN2015/000171

§ 371 Date: Oct. 17, 2016

(30) Foreign Application Priority Data
Apr. 16, 2014 (IN) 1041/DEL/2014

(51) Int. Cl. G06Q 20/36; H04W 4/00; H02J 3/46; H02J 3/38; G06Q 20/40; G06Q 20/32

(52) U.S. Cl. CPC G06Q 20/363; G06Q 20/40145; G06Q 20/327; H02J 3/46; H02J 3/383; H04W 4/008

(57) ABSTRACT

Disclosed is a digital wallet for storing information and carrying electronic transactions between various users. The digital wallet includes a communication interface adapted to send and receive data, a processor and a memory. The memory includes a transaction module adapted to carry an electronic transaction in an offline manner and synchronize the carried electronic transaction when the digital wallet gets communicably coupled to a wide area network, such as the internet. Further, disclosed is a system and method for carrying electronic transactions between various users.

### CROSS REFERENCE TO RELATED APPLICATION

This complete specification is filed in pursuance of the provisional Indian patent application numbered 1041/DEL/2014 filed at India Patent Office on 16 Apr. 2014.

### FIELD OF THE DISCLOSURE

The present disclosure generally relates to the field of wireless electronic transactions, and more particularly, to systems and methods for implementing electronic transactions using wireless digital wallets.

### BACKGROUND OF THE DISCLOSURE

There has been a tremendous increase in the demand of cashless transactions in recent years. There is a fast moving trend towards developing systems and methods which facilitate cashless transactions as a preferred way of financial transactions as compared to cash based transactions. It is envisaged that such cashless transaction has tremendous benefits and convenience and can save huge costs to exchequer by reducing or eliminating the dependence on paper or currency based transactions. More and more people prefer electronic transactions over conventional transactions.

One of the first forms of cashless transactions started with credit cards that are widely accepted by merchants through transaction terminals, Point of Sale (POS) terminals, vending machines, ticketing machines, and the like. In this technology, users can swipe their card and carry out the financial transaction after providing certain authorization information, such as Personal Identification Number, signature, biometrics, and the like. Various other cards, such as debit cards, are more widely used in economies where access to credit is unavailable.

However, all these conventional systems involve a transaction between a user on one side and a merchant terminal on the other side. The merchant terminal is connected to the payment server, bank or some other server at the back end. These conventional systems do not allow peer-to-peer transaction or transactions without the involvement of the some financial institution. Therefore, such conventional systems are highly limited in providing a substitute of paper currency transaction.

The next form of cashless transactions uses contactless technology, such as Radio Frequency Identification (RFID) or Near Field Communication (NFC) to effect transactions, usually between a POS and a customer. The transaction is initiated when the users brings their wireless enabled card in close proximity to a POS terminal or by touching the card to the POS terminal. The card stores information, such as electronic money pre-loaded in the card, and other customer details, and the POS terminal has means for reading the card information and updating information as per the transaction. However, such technology also has various limitations, as it only allows vendor to customer transactions, and further requires the customers to pre-load their cards with money for performing any transaction. Such solutions are also referred to as Pre Paid Financial Instruments. Moreover, such conventional systems generally need an uninterrupted connection to network backbone for facilitating transactions. This is a severe limitation in regions where connectivity to network backbone is marred with problems.

More specifically, both these forms of cashless transaction as mentioned above, attempt to replace cash based transactions with electronic transactions. This allows the users to carry less cash in their physical wallets. However, the users would still need to do cash based transactions in scenarios where they have to pay money to another user (wallet to wallet payment) or in remote areas where the POS cannot be installed due to various reasons including lack of network connectivity, lack of a power source, and other connectivity related issues or where real-time connectivity to the backend (through Wide Area Network (WAN)) is absent.

There have been some solutions developed in recent years to facilitate peer to peer electronic transactions. For example, in U.S. Patent Publication No. 2010/0078471 (Lin et al.), discloses peer-to-peer financial transactions using one or more electronic devices such as a mobile device. The device includes one or more input interfaces, including a camera, image processing software, and communication interfaces to retrieve transaction information from a payment instrument, such as a check, transmit payment information to a financial server and/or another electronic device or conduct a transaction. However, Lin et al does not provide a solution to overcome the problem of implementing the financial transactions using one or more electronic devices such as a mobile device without internet backbone. For example, whenever a user wants to perform financial transaction in a situation of no Internet connectivity, the users are required to wait until he or she gets connected to the internet for enabling the financial transaction. In the above situation, the above system fails to implement financial transactions between various users in an offline efficient and economical manner, taking into consideration the limitations of coverage of Wide Area Network, such as the internet.

In another application, WIPO Patent Publication No. PCT/PT2013/000005 by Fernandes, discloses “Portable device for electronic payments” or “Electronic wallet calculator for cashless transactions”. The system disclosed relates to a combined system of conversion, calculation and transmission of processed data for immediate and present payments and revenues, through portable or fixed devices of close but contactless communication, which, in most models, is similar to a wallet calculator or a mobile phone. These calculators enable basic functions of arithmetic operations designed to be subtraction (debit) or addition (credit), whenever two similar or compatible devices establish a link of connectivity and synchronization of the processed, encoded and encrypted data between themselves, in a secure and off-line way, using infrared, radio frequency of short distance, or other forms of “contactless” transmission. However, the system as disclosed in this solution is limited only to the basic functions of arithmetic operations designed to be subtraction (debit) or addition (credit), and is severely disabled in operation. Further, the system disclosed is incapable of carrying and reconciling large volume of transactions with financial servers taking into consideration the limitations of coverage of Wide Area Network, such as the internet. Further, the systems as disclosed in prior art does not provide means for conducting transaction simultaneously with multiple digital wallets, wherein different wallets are in different stages of transaction, including but not limited to, power on, discovery, connection, encryption/decryption, transaction and completion.

In nutshell, these solutions as described above require a POS terminal to always be connected to the Wide Area network (WAN) all the time for at least two purposes. The first purpose is authorization of the transaction and the second purpose is synchronization of the credit/debit information with the financial institutions database. For example, debit card systems almost always require real time connection to the financial institution, since wallet balance information is maintained with the backend databases. This requirement severely limits the capability of transactions in situation of connectivity downtimes. Accordingly, the aforesaid solutions are severely limited in carrying high volumes of transactions keeping into mind the limitations regarding penetration of Wide Area Networks (WANs) in the present day and age.

### SUMMARY OF THE DISCLOSURE

In view of the foregoing disadvantages inherent in the prior-art and the needs as mentioned above, the general purpose of the present disclosure is to provide a system and method for carrying electronic transactions that is configured to include all advantages of the prior art and to overcome the drawbacks inherent in the prior art offering some added advantages.

To achieve the above objectives and to fulfill the identified needs, in one aspect, the present disclosure provides a digital wallet for carrying electronic transactions between various users. Specifically, the digital wallet enables carrying electronic transactions in an offline manner or mode, i.e., without the need of an omnipresent and uninterrupted connectivity to a network backbone. The digital wallet includes a communication interface adapted to send and receive data, a processor and a memory. The memory includes a transaction module adapted to carry an electronic transaction in an offline manner and synchronize the carried electronic transaction when the digital wallet gets communicably coupled to a wide area network, such as the internet. Further, the memory is adapted to store financial and personal information securely.

In another aspect, the present disclosure provides a system for implementing electronic transactions between various users. The system includes a server for storing financial and personal information of the users. Further, the system includes at least one transaction terminal capable of connecting to the server via a wide area network. The system further includes one or more digital wallets capable of communicating with each other and with the transaction terminal. Each of the one or more digital wallets includes a communication interface adapted to send and receive data, a processor, a memory having a transaction module adapted to carry an electronic transaction in an offline manner and synchronize the carried electronic transaction when the digital wallet gets communicably coupled to at least one transaction terminal.

In another aspect, the present invention provides a system for implementing electronic transactions between various users. The system includes a server for storing financial and personal information of the users. Further, the system includes one or more digital wallets capable of communicating with each other. Each of the one or more digital wallets includes a communication interface adapted to send and receive data, a processor, and a memory having a transaction module adapted to carry an electronic transaction in an offline manner and synchronize the carried electronic transaction when the digital wallet gets communicably coupled to the at least one transaction terminal.

In another aspect, the present invention provides a method for implementing electronic transactions between various users, each of the users carrying a digital wallet as described above. The method includes enabling a first digital wallet. After enabling the first digital wallet, the method includes selecting one of the one or more digital wallets to transact with, and sending an electronic transaction request to the selected digital wallets from the first digital wallet via a communication means. Further, the method includes carrying the electronic transaction between the first digital wallet and the selected digital wallets in an offline manner, wherein the electronic transaction gets synchronized with a server when either of the first digital wallet or the selected digital wallet gets communicably coupled through the terminal to the wide area network, such as the internet.

In another aspect, the present invention provides another method for implementing electronic transactions between various users, wherein each of the users is carrying a digital wallet. Besides this at least one transaction terminal is present. The method includes enabling at least one transaction terminal. Thereafter, the method includes selecting one of the one or more digital wallets and sending an electronic transaction to the selected digital wallet from at least one transaction terminal via a communication means. The method further includes carrying the electronic transaction between at least one transaction terminal and the selected digital wallet in an offline manner, wherein the electronic transaction gets synchronized with a server when either of the selected digital wallet gets communicably coupled to a wide area network. In one embodiment, the selected digital wallet gets couple to the wide area network through the transaction terminal.

In another aspect, the present invention provides a computer program product with executable instructions which, when executed by one or more processors provides the functionality of digital wallet. The computer program product allows enabling of a digital wallet and selects one of the one or more of the digital wallets to transact with. Thereafter, the computer program product sends an electronic transaction request to the selected digital wallet via a communication means. The computer program product further includes carrying the electronic transaction in an offline manner, wherein the electronic transaction gets synchronized with a server when one of the one or more digital wallets gets communicably coupled to a wide area network. In one embodiment, one of the one or more digital wallets gets couple to the wide area network through the transaction terminal.

Further, it should be understood that the transaction between two digital wallets is adapted to take place in an offline manner without the need of any device for synchronization of the transaction at the time when the transaction is taking place.

In various embodiments, the digital wallet further has the ability to back-up its data to a person's mobile phone memory or computer memory so that this data can be retrieved by the individual if their wallet is lost or stolen.

In another embodiment, the digital wallet is provided with a communication means for receiving and displaying financial or other information, or advertisements.

This together with the other aspects of the present invention along with the various features of novelty that characterize the present disclosure is pointed out with particularity in claims annexed hereto and forms a part of the present invention. For better understanding of the present disclosure, its operating advantages, and the specified objective attained by its uses, reference should be made to the accompanying descriptive matter in which there are illustrated exemplary embodiments of the present invention.

### BRIEF DESCRIPTION OF THE DRAWINGS

The advantages and features of the present disclosure will become better understood with reference to the following detailed description and claims taken in conjunction with the accompanying drawing, in which:

FIG. 1A-1B illustrate a block diagram of a digital wallet of the present invention, according to various embodiments of the present invention;

FIG. 2 illustrates one main function of a digital wallet when implemented as standalone hardware device (“Hardware Based Digital Wallet”), according to various embodiments of the present invention;

FIG. 3 illustrates a digital wallet being implemented as a Software Based Digital Wallet, with the said digital wallet running on a tablet, mobile phone, or similar device instead of a standalone hardware device, according to various embodiments of the present invention;

FIG. 4 illustrates a perspective view of the digital wallet when implemented as a wearable device, according to various embodiments of the present invention;

FIG. 5 illustrates a system for carrying electronic transactions illustrating a communication between a digital wallet and a transaction terminal, according to various embodiments of the present invention;

FIGS. 6A-6C illustrate a communication between two digital wallets, according to various embodiments of the present invention;

FIG. 7A illustrates a communication between a digital wallet and a transaction terminal, according to various embodiments of the present invention;

FIG. 7B illustrates compatibility of the digital wallet of the present invention with legacy POS terminals that are already known conventionally, by use of an adaptor module according to various embodiments of the present invention;

FIG. 8A illustrates a communication between multiple digital wallets and a transaction terminal, where the transaction terminal is remotely coupled to a server according to various embodiments of the present invention;

FIG. 8B illustrates a transfer or remittance from one digital wallet to any other digital wallet, according to various embodiments of the present invention;

FIG. 8C illustrates a transfer or remittance from one digital wallet to a software based digital wallet that is directly connected to the server, according to various embodiments of the present invention;

FIG. 8D illustrates a transfer or remittance from one software based digital wallet to another software based digital wallet, when both the wallets are directly connected to the server, according to various embodiments of the present invention;

FIG. 8E illustrates a transfer or remittance from one software based digital wallet to another entity that acts as the beneficiary, according to various embodiments of the present invention;

FIG. 9 illustrates an operational method between the digital wallet and the transaction terminal, according to various embodiments of the present invention;

FIG. 10 illustrates an operational method to store information about multiple users on the digital wallet so that it can be used by multiple users, according to various embodiments of the present invention.

FIGS. 11A and 11B illustrate configuration proximity aspect of the digital wallet, according to various embodiments of the present invention;

FIGS. 12A and 12B illustrate flow charts of how a typical payment transaction may happen between the digital wallet and the transaction terminal, according to various embodiments of the present invention;

FIGS. 13A and 13B illustrate flow charts of how a payment transaction may happen between two digital wallets, according to various embodiments of the present invention;

FIG. 14 illustrates the various functionalities that the wallet may provide to the end user, according to various embodiments of the present invention;

FIG. 15 illustrates a method of distributing a targeted advertisement, alerts or any other messages to digital wallets of the present invention, according to various embodiments of the present invention; and

FIG. 16 illustrates a flow chart of how payment transaction may happen between banking terminal and account holders of digital wallets, according to various embodiments of the present invention.

Like numerals refer to like elements throughout the present disclosure.

### DETAILED DESCRIPTION OF THE DISCLOSURE

The foregoing descriptions of specific embodiments of the present disclosure have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

The term ‘cash’ or ‘currency’ do not denote a limitation to physical currency, money or its equivalent; but rather denotes any accruable, tradable, transferrable financial instrument, object or record.

The terms “a” and “an” herein do not denote a limitation of quantity, but rather denote the presence of at least one of the referenced item.

The terms “having”, “comprising”, “including”, and variations thereof signify the presence of a component.

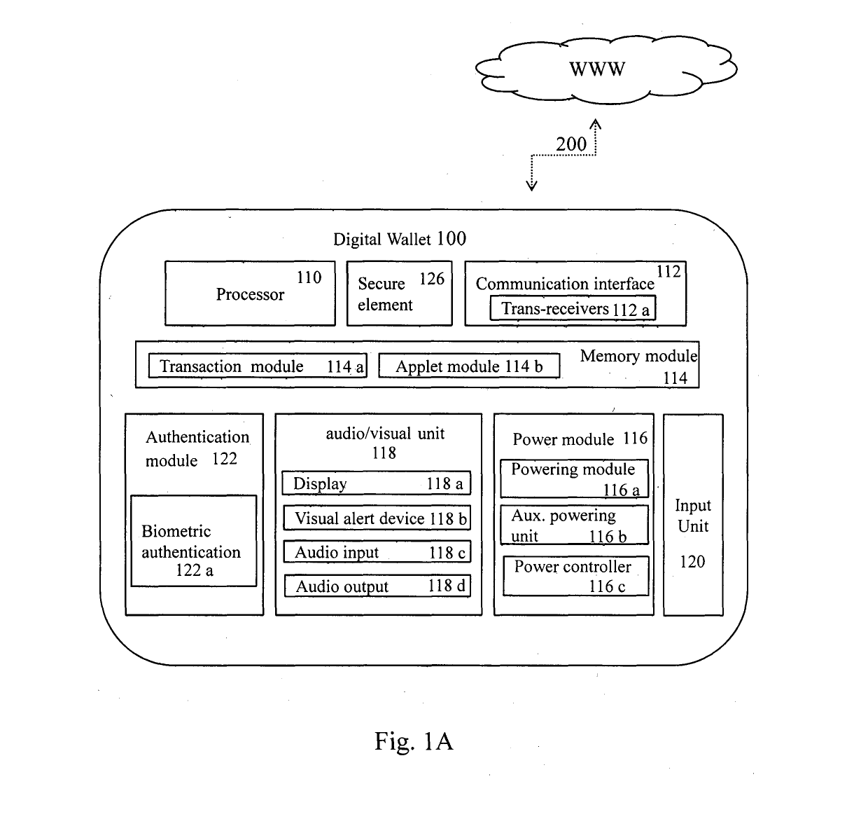

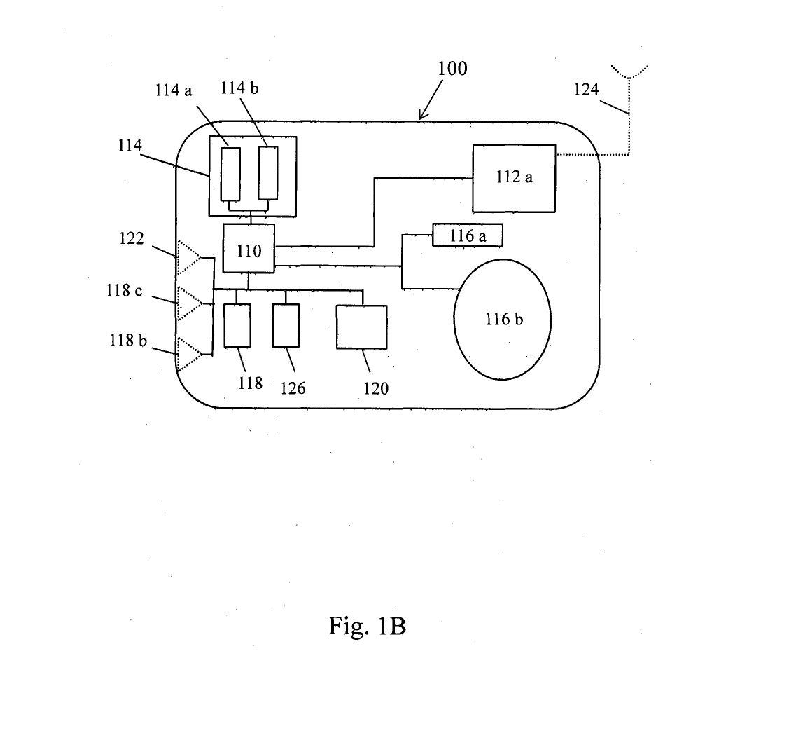

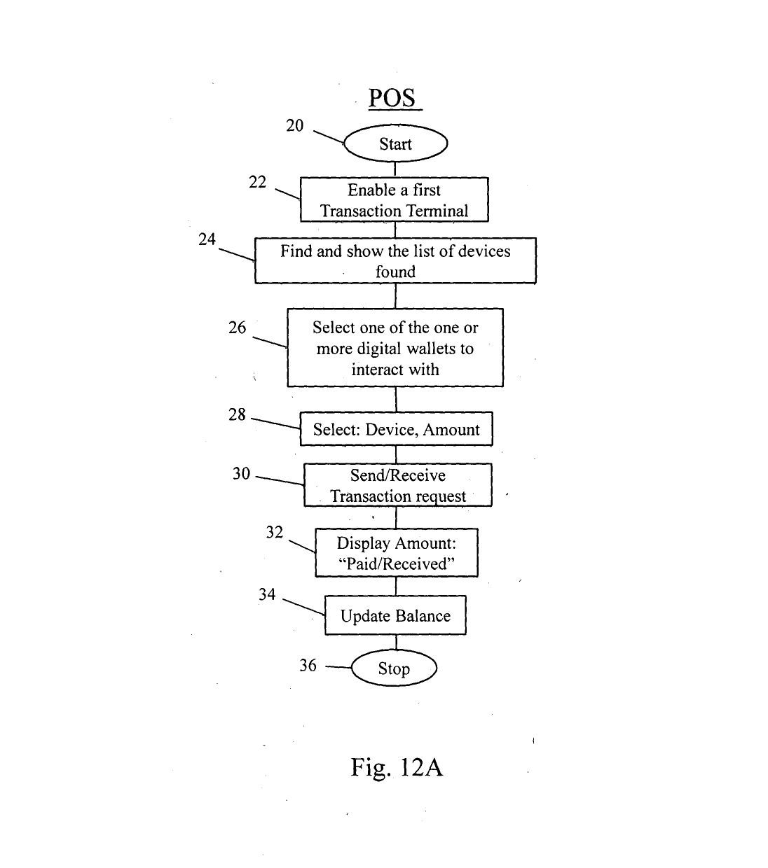

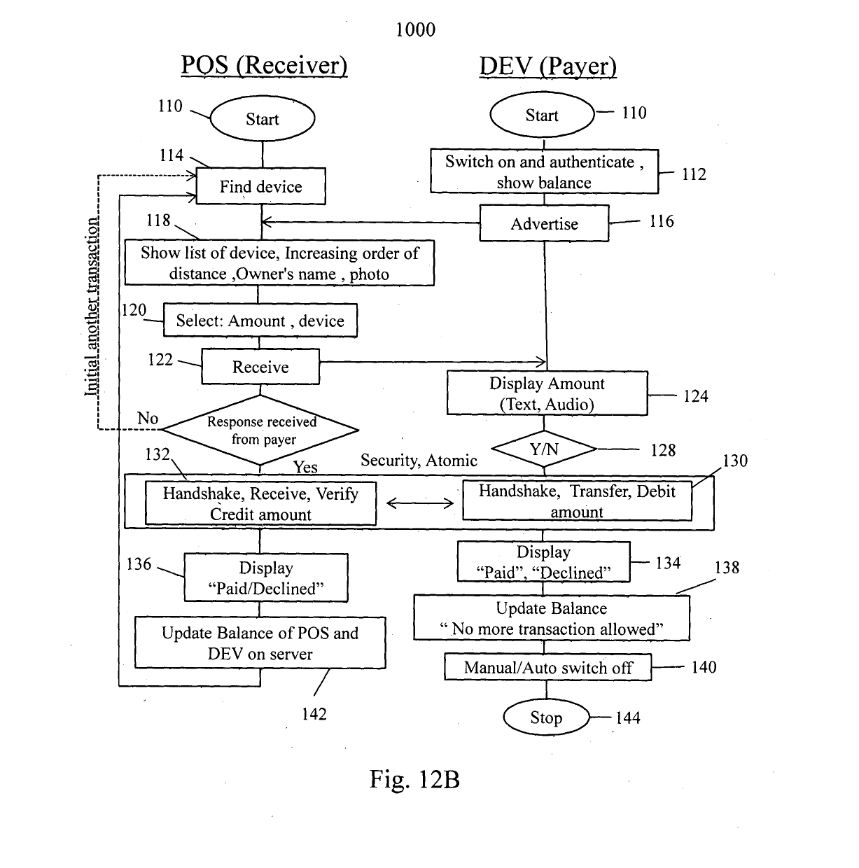

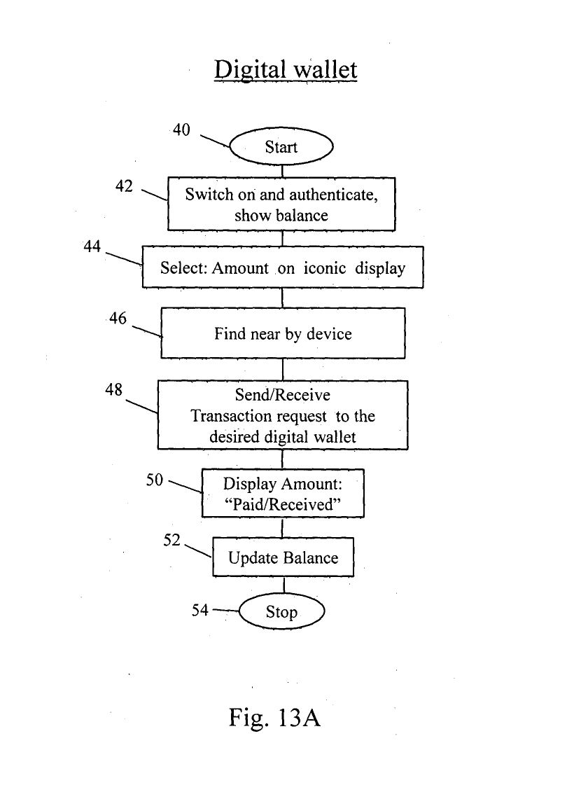

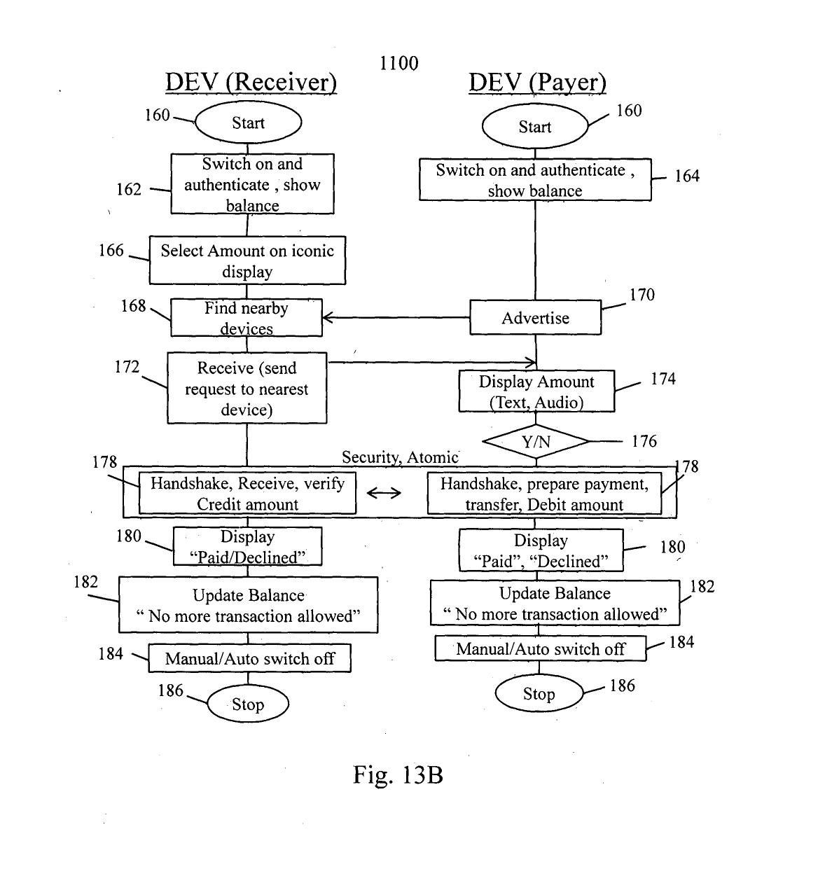

The present invention provides a digital wallet for carrying electronic transaction. The digital wallet and its usage are described with reference to FIGS. 1-11, whereas the method of for carrying electronic transactions using the digital wallet is shown with reference to various FIGS. 12-13. It should be apparent to a person skilled in the art that the term “digital wallet” as referenced herein refers to an electronic device that allows an individual to make electronic commerce transactions. The transactions may include peer to peer transfer of currency, purchasing items in a Point of Sale (POS) or transaction terminal or transacting with the POS for transfer of currency or purchase of items. The electronic device may be a stand-alone device especially configured to carry the electronic transactions as described, or may be a conventional device, which may be adapted to carry the electronic transactions by implementing the present invention. The digital wallet and system for carrying the electronic transactions will now be explained with reference to FIGS. 1-11.

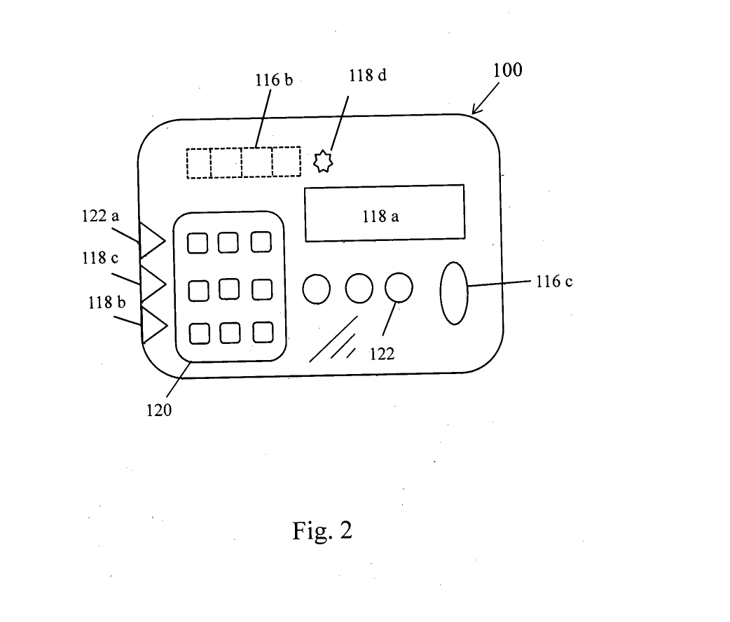

Referring to FIGS. 1A, 1B and 2, there is shown a digital wallet 100. The digital wallet 100 includes a communication interface 112. The communication interface 112 is adapted to send data to other digital wallets and receive data from other digital wallets or to other components of the system, such as Point of Sale (POS) device, and the like. In an exemplary embodiment, the communication interface 112 may include one or more wireless trans-receiver 112a, which is capable of transmitting or receiving data.

Further, the digital wallet 100 includes a Wireless Antennae 124. The wireless antenna 124 is adapted to connect the digital wallet 100 wirelessly with other devices, such as transaction terminals and other digital wallets.

Furthermore, the digital wallet 100 includes a processor or a microprocessor 110 for executing instructions, and a memory 114 storing some instructions. Specifically, the memory 114 includes a storage means for storing financial or user's personal information. Examples of information includes, but are not limited to, transaction information, various currency types, Unique Identification (UIADI) including Biometrics information, Social Security Number (SSN), Aadhar number, Driver's License (DL) Number, loyalty points information, frequent flyer miles information, club membership information, location information, and the like, for one or more users using the digital wallet 100.

In various embodiments, the memory 114, also includes an applet module 114b. This module 114b may contain various secure applets, adapted to perform intended function. In one embodiment, the secure applet could be used for validation of a person, driver license, and the like. In another embodiment, it could be used as a payment instrument for local transportations.

In various embodiments, the memory 114 could be in one or more physical manifestation. Furthermore, the memory 114 includes a transaction module 114a adapted to carry an electronic transaction in an offline manner. The transaction module 114a may be a software application having computer readable instruction, computer program and the like. In one embodiment, the transaction module 114a may be downloadable in the memory 114 of the digital wallet 100. Particularly, the transaction module 114a may be downloadable from any network or storage source, for example, but not limited to, Internet, CD ROM, USB and the like. For example, a user of the digital wallet 100 may download the transaction module 114a from the internet and install the said transaction module 114a on the digital wallet 100. Further, the memory 114 may include a Random Access Memory (RAM), Read Only Memory (ROM), and FLASH memory and the like.

Further, the transaction module 114a is adapted to perform various functions. In one embodiment, the transaction module 114a is adapted to validate the carried electronic transaction in the offline manner, as per the invention. However, such function of the transaction module 114a should not be construed as a limitation to the present invention. Accordingly, the transaction module 114a may be capable of performing other functions in the digital wallet 100.

Referring to FIGS. 1A, 1B and 2, the digital wallet 100 further includes various security features for securing the digital wallet 100. The security features are important to prevent unauthorized access of the digital wallet 100, secure exchange of data with other wallets, and to make sure that only valid users are able to use the digital wallet 100.

In one embodiment, the digital wallet 100 includes an authentication module 122 coupled to the transaction module 114a. The authentication module 122 is adapted to authenticate the user of the digital wallet 100. It will be apparent to a person skilled in the art that security is paramount for these digital wallets, such as digital wallet 100. In one embodiment, the authentication module 122 may be a secure chip or a biometric type authentication module. In this case, the authentication module 122 further includes a Biometric Input unit 122a which may be adapted to provide additional support for biometric identification like finger print, retina, voice or facial detection. It enhances the overall security of the digital wallet 100. In addition, in various embodiments of the present invention, the digital wallet 100 may include multiple biometric units, for example camera, iris scanner, retina scanner, DNA identification device and the like which may strengthen the user authentication for accessing the digital wallet 100. However, such example of the biometric type authentication should not be construed as a limitation to the present invention. Accordingly, in another embodiment, the authentication module 122 may be any other authentication module, such as Person Identification Number (PIN) or signature based authentication module.

The digital wallet 100 further includes a secure element 126 for providing enhanced security to the digital wallet 100. It includes security keys and cyphers that are used to establish the identity of the device, functionality to encrypt and decrypt all communication that happens with other devices on the wireless network and functionality to store the sensitive information on the device in a secure manner. The encryption of the communication is highly essential in maintaining the security of the digital wallet 100. The secure element 126 also provides for information storage, preparation of payment and verification of payment between digital wallets, such as digital wallet 100.

Referring to FIGS. 1A, 1B and 2, the digital wallet 100 includes a power module 116 adapted to harvests energy from the environment and conserve power requirements of the digital wallet 100. The power module 116 satisfies the power need of the digital wallet 100. The power module 116 may include various oscillators, timers and other circuitry elements for such purpose.

In one embodiment of the present invention, the power module 116 includes powering unit 116a (such as a rechargeable battery source), an auxiliary powering unit 116b, which may include one or more solar panel units, and a power controller unit 116c. The power controller 116c is adapted to cease power of the digital wallet 100 in one or more predefined situations.

In one embodiment, the power controller 116c is adapted to control the power supply in one or more predefined situations. The predefined situations includes a situation where the power controller 116c automatically turns off or reduce power consumed by the digital wallet 100 after the completion of the electronic transaction or in a situation where the digital wallet 100 is inoperable for predetermined duration of time, for example 5-10 seconds. This assists the digital wallet 100 to save power, a key requirement for operating in remote area.

Referring to FIGS. 1A, 1B and 2 again, in one embodiment, the digital wallet 100 also includes an audio/visual unit 118 adapted to provide various visual/Audio notification including alerts. Suitable examples of alerts or tags may include tags for events such as Deposit or Withdraw in the linked Bank Account, Low Balance, Low Battery, invalid authentication and the like. This makes the digital wallet 100 easy to operate and more importantly disable friendly.

In one embodiment, the audio/visual unit 118 includes a display 118a, an audio Input 118b, an Audio Output 118c and a Visual alert device 118d, are optional features of the present invention. The Audio Input 118b may be adapted to provide biometric identification of the user of the digital wallet 100 by voice recognition method. Further, the Audio Output 118c is adapted to provide audio feedback to the user. This audio output functionality is extremely beneficial for impaired or less educated or illiterate users.

Further, the digital wallet 100 includes a user Input unit 120. The user Input unit 120 is an essential interface between the digital wallet 100 and the user thereof. The Input unit 120 could be through a touch interface in lieu of a physical button. The user Input unit 120 uses iconic or alphanumeric based input. Accordingly, the Input unit 120 may include one or more keys for allowing the user to enter the input. However, such examples of the Input unit 120 should not be construed as a limitation of the present invention. Accordingly, the Input unit 120 may also be a gesture based, or a voice based input unit, or any other type of Input unit 120 which allows a seamless interfacing between the user and the digital wallet 100.

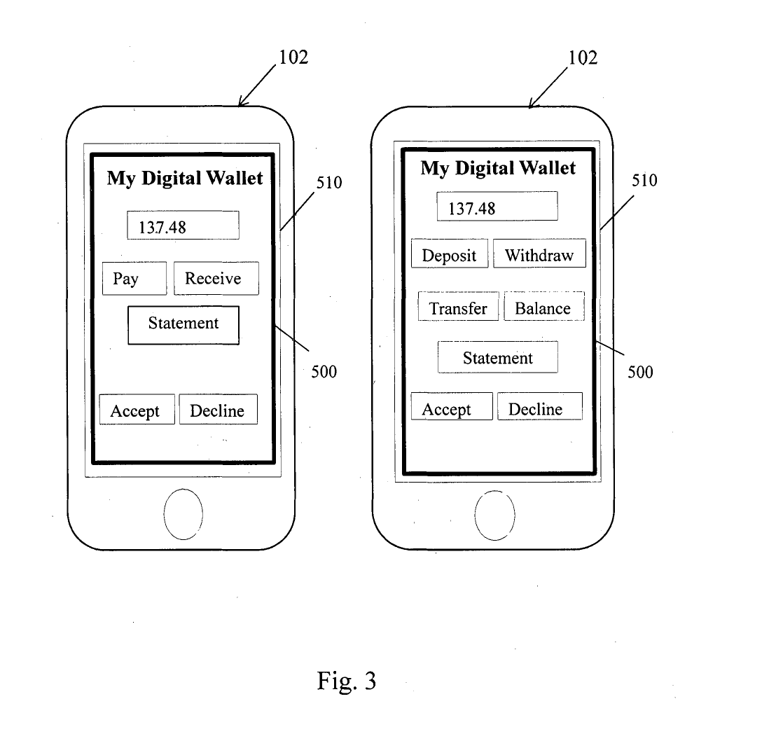

In one embodiment of the present invention, the digital wallet 100 may be implemented entirely at a software level. In such scenario, the digital wallet 100 may be in form of a software module 500 (as shown in FIG. 3) configurable onto known in the art data processing devices 102, such as smart phones, tablet computers and the like, as shown in FIG. 3. It will be apparent to the person skilled in the art, that the data processing device 102 may already include the communication interface 112, the processor 110, the secure element (not shown in FIG. 3) and the memory 114 (not shown in the FIG. 3) inherently in the device 102.

In one embodiment of the present invention, the digital wallet 100 may be built into a form factor that can attach into a Smartphone or tablet, either externally or internally. For example, the digital wallet 100 may fit into the Smartphone into the USB, Audio, SIM card or SD card slot.

A reference made to FIG. 3 illustrates an interface of the digital wallet 100 at the software level. As shown in FIG. 3, the module 500 is configurable on the device 102. An interface 510 as shown in FIG. 3 illustrates options to pay and receive, for example to pay currency, reward points, shopping credits or other such payment options. An interface 510 as shown in FIG. 3, illustrates options to conduct transactions, such as banking transactions including Deposit, Withdraw, Transfer, and Balance Inquiry. However, it should be clearly understood that such transaction and/or schematic layout of the digital wallet 100 should not be construed as a limitation to the present invention. The layout is highly adaptable and customizable according to the needs and desires of the user. The transactions by the digital wallet 100 are customizable in accordance with various situations.

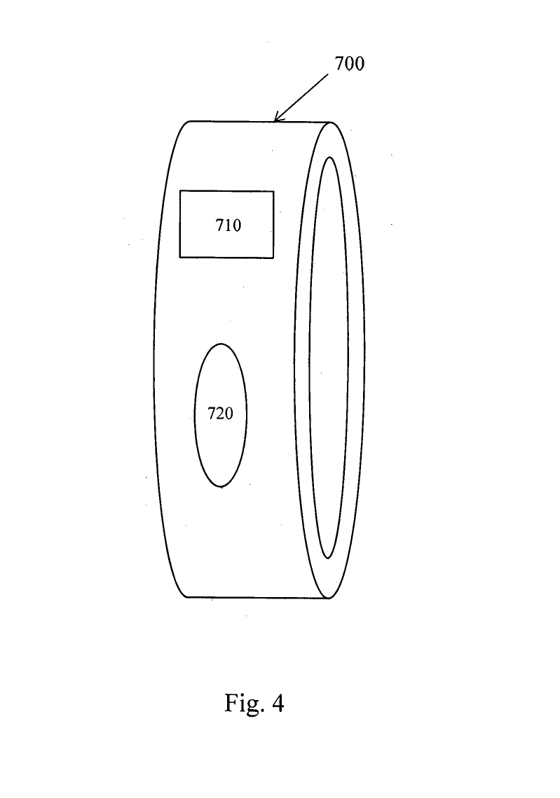

Referring to FIG. 4 there is shown a digital wallet 700 when implemented as a wearable device, such as a wrist band, bracelet, ring or necklace. The various components include a wearable unit 700, a display 710 for displaying information, at least one button 720 allowing users to perform operations. This implementation gives tremendous portability to the digital wallet 700. In other words, the user is free to carry the digital wallet 700 to any place he or she so desires easily and hassle free. Further, such implementation could find application in amusement parks, theatres, and other such places, as a closed or semi-closed financial instrument.

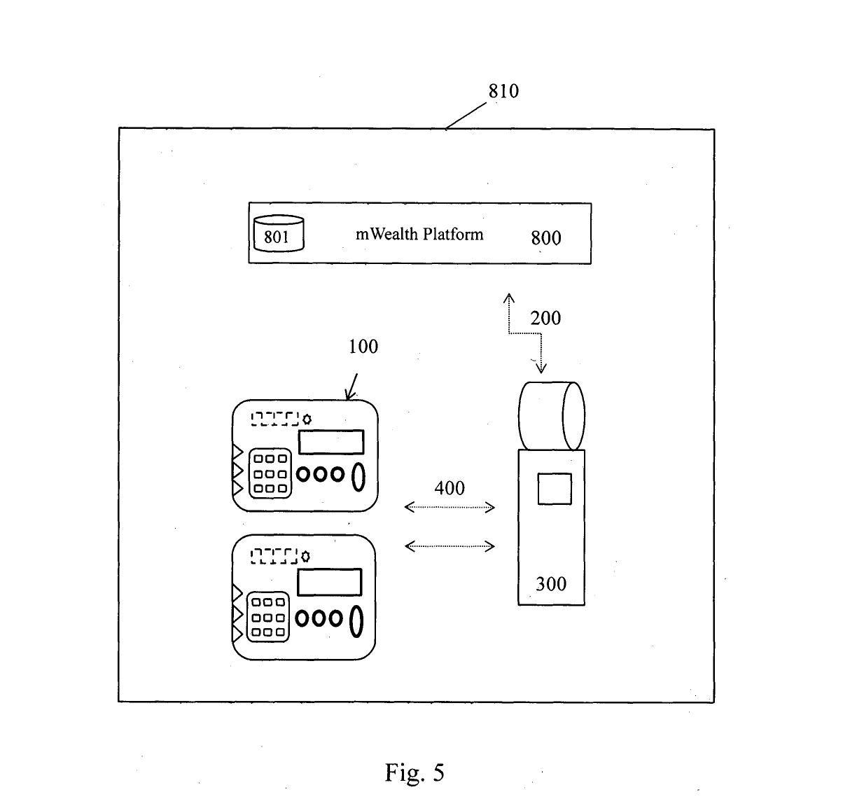

Referring to FIG. 5, there are illustrated electronic transactions between digital wallets 100 with other devices via low power short range communication 400. In FIG. 5, there is shown a system platform 810, which includes a server 800, at least one transaction terminal 300, and one or more digital wallets, such as digital wallets 100.

Further, the server 800 includes a database 801 for storing financial and user specific information, such as loyalty points, frequent flyer miles, and club membership information, financial and personal information of the users. The server 800 may be a bank server, merchant server, financial institution server, any third party server and the like.

The transaction terminal 300 may be a kiosk, a point of sale (POS), an automated teller machine (ATM), a synchronization pod, a transaction terminal or a merchant machine and the like, and is capable of connecting to the server 800 via the wide area network (WAN) interface 200 or with any wired or wireless network.

The digital wallets 100 are capable of communicating with each other and with a Point of Sale (POS) or transaction terminal 300 via low power short communication 400 for facilitating transactions in an offline manner without the need to be connected to the Wide Area Network, such as the internet. In other words, the digital wallets 100 may be operable and capable of carrying numerous transactions without connecting to the server 800. When the carried electronic transactions are required to be reconciled, the digital wallets 100 may come in communication with the server 800 via the WAN interface 200.

However as per various embodiments of the present invention, the digital wallet 100 may be able to carry the electronic transactions without the need of reconciliation with the server 800. In other words, various digital wallets, such as the digital wallet 100, may be adapted to transact with each other without any of the digital wallets reconciling with the server 800. The digital wallets 100 may reconcile with the server 800 only in limited situations. In one situation, the reconciliation is required to be done only when the digital wallet 100 may be out of currency or user wants to update his/her transactions at his/her own will.

In one embodiment of the present invention, the digital wallets 100 are capable of communicating with transaction terminal 300 after connecting via low power short communication 400. Further, the transaction terminal 300 is adapted to store all the information including electronic transaction information of the digital wallets 100 during synchronization. After synchronization, the electronic transaction information is updated for reconciliation to the server database 801 whenever the transaction terminal 300 gets connected to the server 800 via World Wide Web (WWW) through the WAN interface 200.

In another embodiment of the present invention, the digital wallets 100 are capable of connecting the World Wide Web (WWW) through wireless network or WAN interface 200 and update all the carried electronic transaction information to the server 800 automatically or manually without the need to connect to the transaction terminal 300 or any third party device.

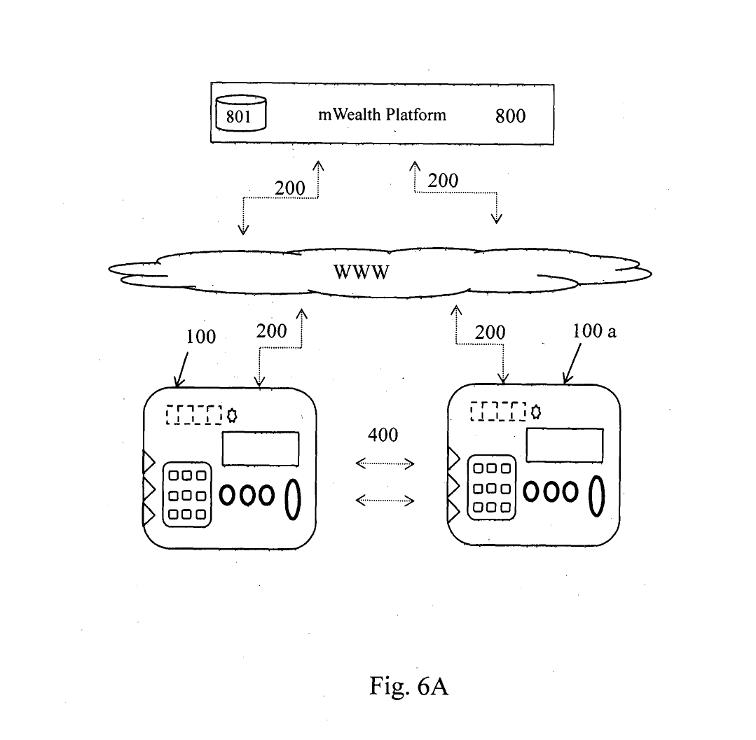

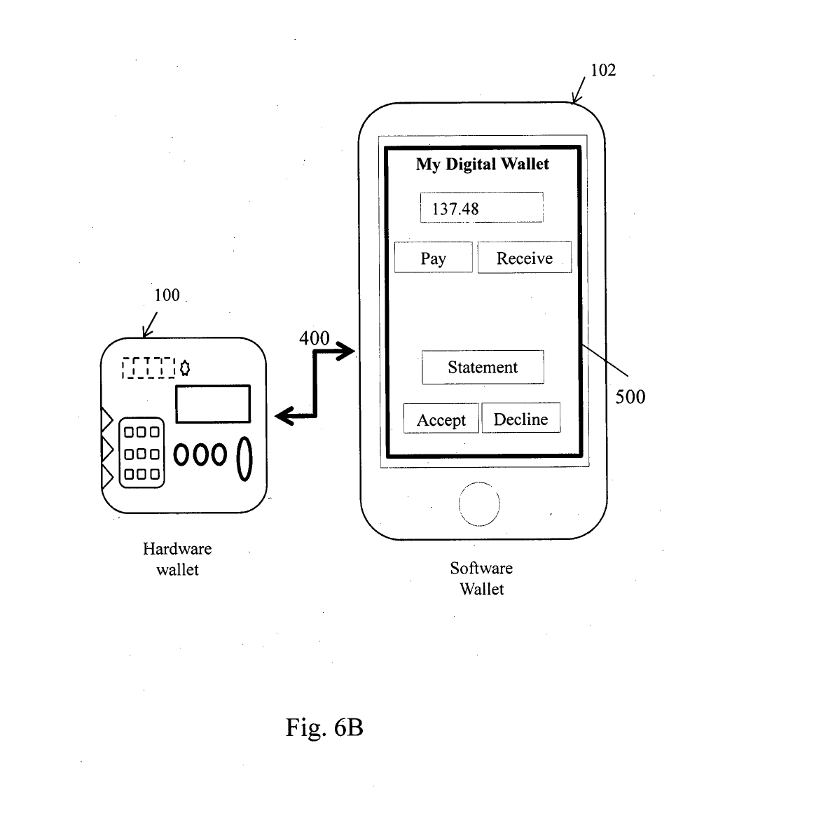

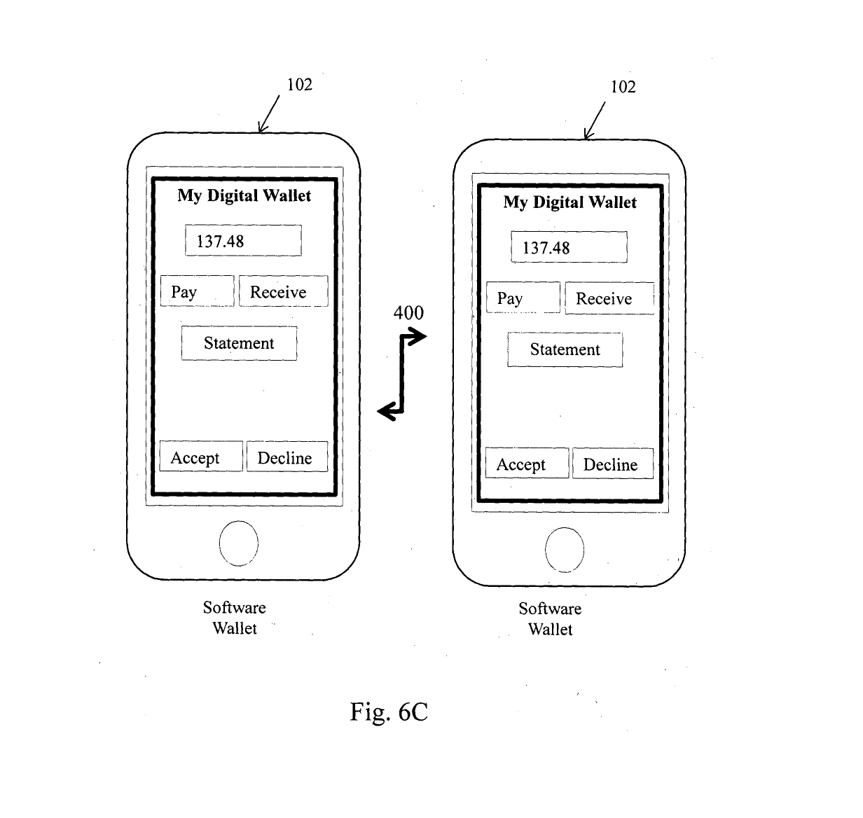

The operation of the digital wallets, such as the digital wallet 100, for carrying out electronic transactions with each other and with transaction terminal, such as transaction terminal 300 will now be explained. The entire process of conciliation and reconciliation of electronic transactions will also be explained. Reference is made from FIG. 6A-11.

FIG. 6A illustrates a communication between two digital wallets 100 (Implemented as a hardware device) and via a communication medium 400. The digital wallets 100 are capable of communicating with each other via low power short communication 400 for facilitating transactions in an offline manner without the need to be connected to the Wide Area Network, such as the internet. This carried transaction gets synchronized whenever either of the first digital wallets 100 gets communicably coupled to the server 800 via the WAN interface 200. In one embodiment, the first digital wallet 100 gets couple to the server 800 through the transaction terminal 300.

FIG. 6B illustrates a communication between two digital wallets, first digital wallet 100 implemented as a hardware device) and a second digital wallet 102 (implemented as a software application referred to as software wallet 102) via a communication medium 400. Further, the two digital wallets) facilitate the electronic transactions in an offline manner without the need to be connected to the Wide Area Network. This carried transaction gets synchronized when either of the first digital wallet 100 or the second digital wallet 102 gets communicably coupled to the server 800 via the WAN interface 200 (as shown in FIG. 6A). In one embodiment, the first digital wallet 100 or the second digital wallet 102 gets couple to the server 800 through the transaction terminal 300.

FIG. 6C illustrates a communication between a first digital wallet 102 (Implemented as a software application) and a second digital wallet 102 (Implemented as a software application) via a communication medium 400. In this particular case, the transaction between the first digital wallet 102 and the second digital wallet 102 is carried out without the need of server 800 (shown in FIG. 6A). This carried transaction gets synchronized whenever either of the first digital wallet 102 or the second digital wallet 102 gets communicably coupled to the server 800 (as shown in FIG. 6A) via the WAN interface 200. In one embodiment, the first digital wallet 100 or the second digital wallet 102 gets couple to the server 800 through the transaction terminal 300.

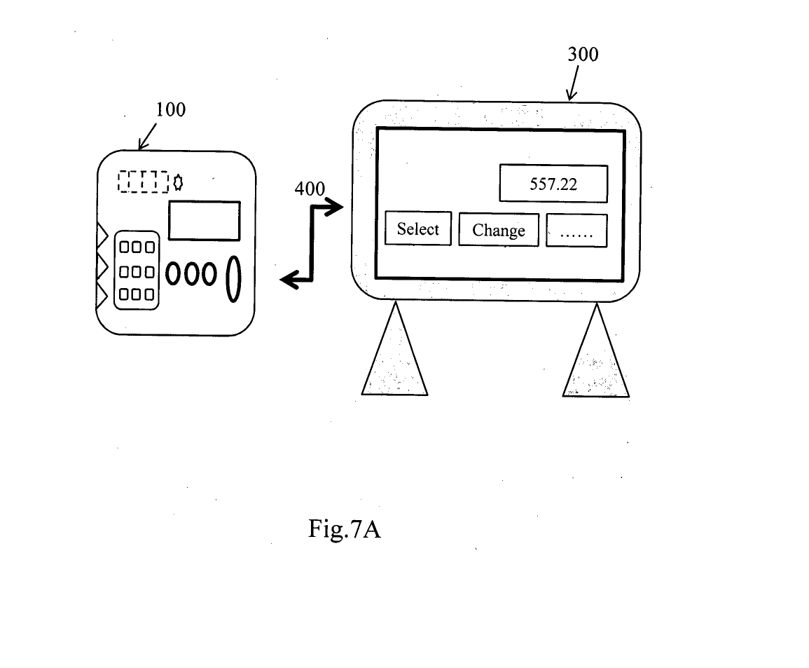

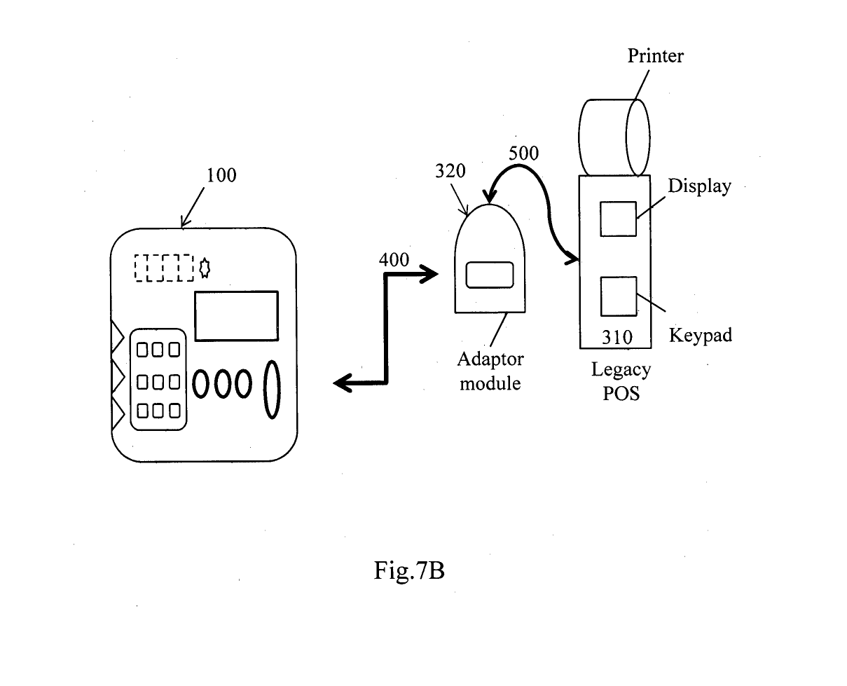

Furthermore, FIG. 7A illustrates a communication between first digital wallet 100 with a transaction terminal 300 over a communication medium 400. The transaction terminal 300 is offline in this illustration. This means that it is not connected to the WAN to access data from the server 800 (as shown in FIG. 6A). Although only one digital wallet 100 is shown in this illustration, in practice, multiple digital wallets 100 may be doing transaction with the transaction terminal 300 terminal at the same time. Theses carried transaction gets synchronized when either of the first digital wallets 100 gets communicably coupled to the server 800 (as shown in FIG. 6A) via the WAN interface 200. In one embodiment, the first digital wallet 100 gets couple to the server 800 through the transaction terminal 300.

FIG. 7B illustrates compatibility of the Digital Wallet 100 with existing transaction terminal 300 that are conventionally known, or in other words, that are already there in the market. This is very useful to allow features of the digital wallet to be used with the existing infrastructure that is already in place. The main components are a digital wallet 100, wireless medium 400 over which the digital wallet 100 communicates, legacy transaction terminal device 310 (for example the transaction terminal 300 devices that are installed in supermarkets), adaptor module 320 to translate the messages from the digital wallet 100 to the protocol that the legacy transaction terminal 310 supports, and Interface 500 of the adaptor module 320 to the legacy transaction terminal 310 device (for example a USB interface).

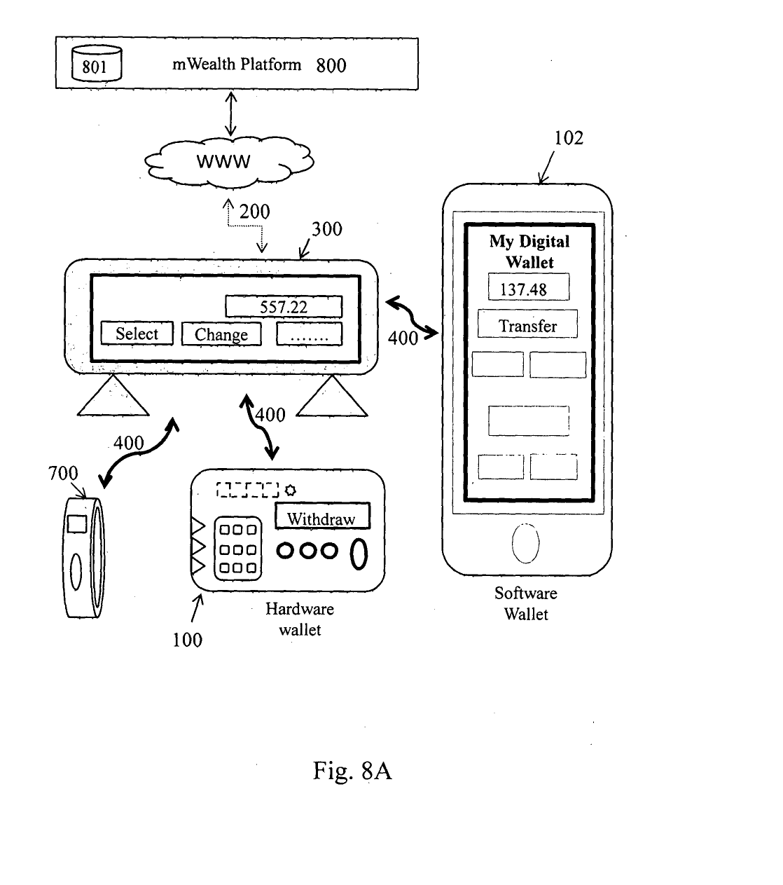

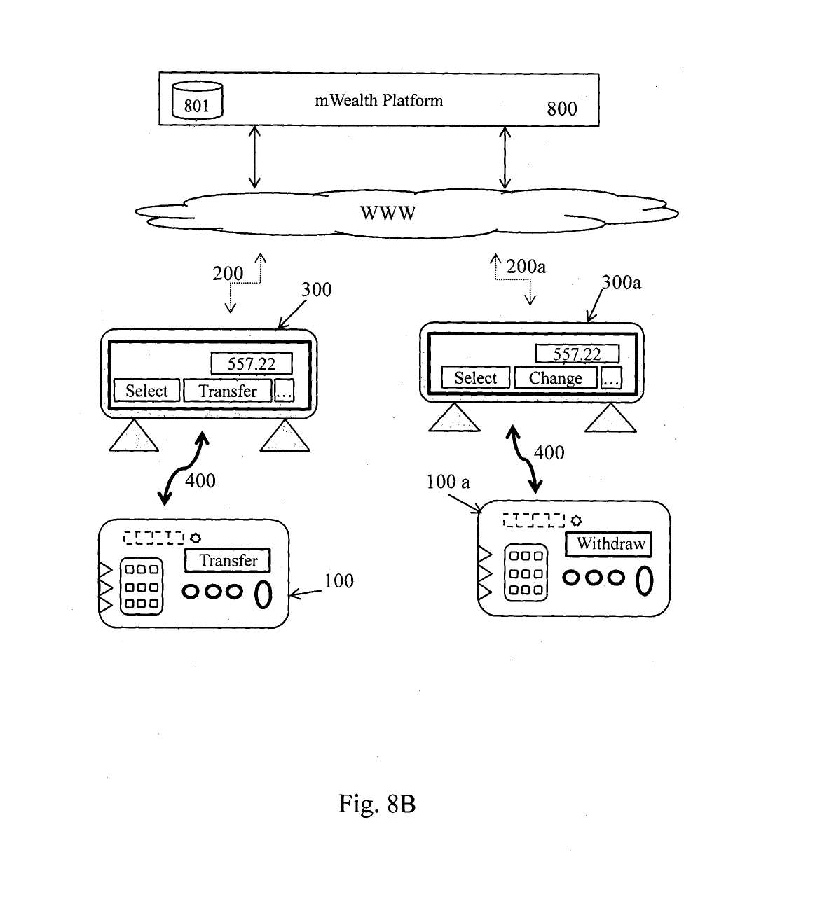

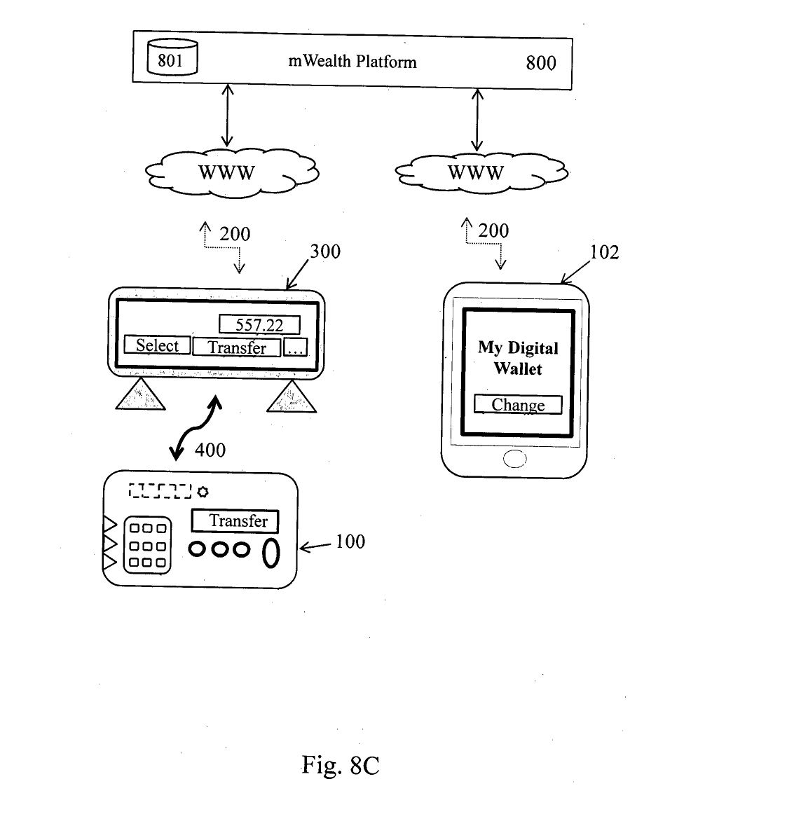

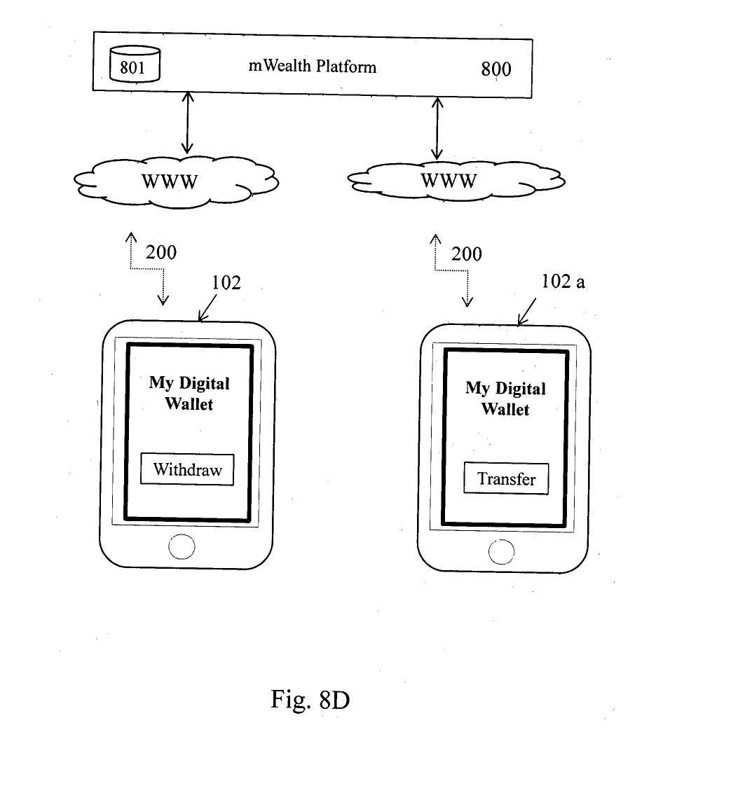

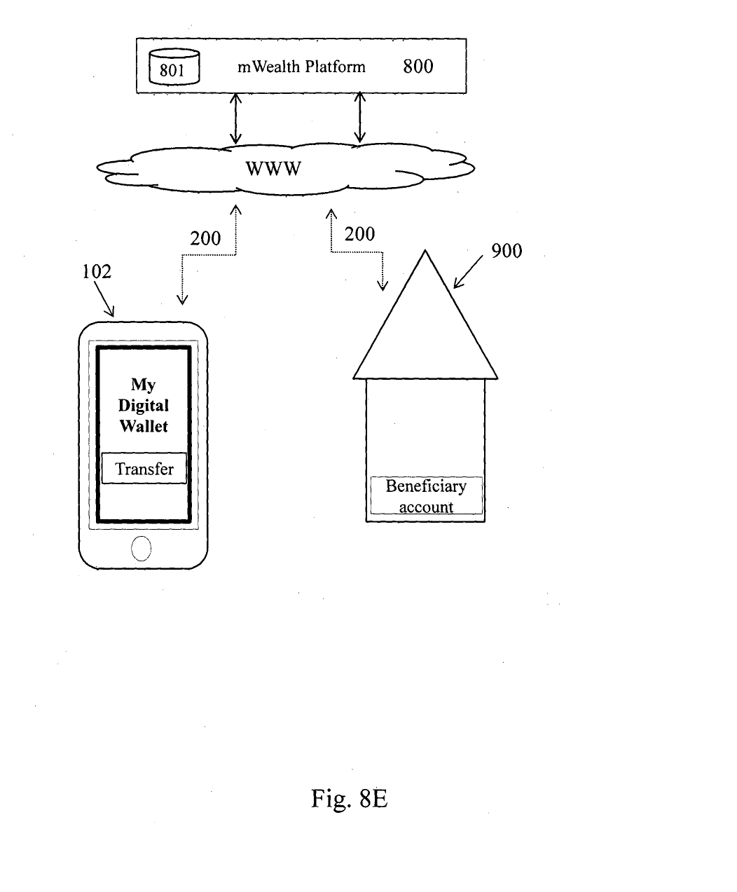

FIG. 8A illustrates a communication between multiple digital wallets, such as digital wallets 100 and a transaction terminal 300. As shown in FIG. 8, multiple digital wallets 100, 102 are in communication with the transaction terminal 300. This transaction terminal 300 can go, online, that is it may get connected to the server platform 800, which may be hosted over WAN interface 200, such as Internet.

The multiple digital wallets 100, 102 are in communication with the transaction terminal 300 for facilitating the electronic transactions in an offline manner without the need to be connected to the Wide Area Network 200, via a communication medium 400. This stored transaction gets synchronized whenever either of the first digital wallet 100 or the second digital wallet 102 and the transaction terminal 300 gets communicably coupled to the server 800 via the WAN interface 200 (shown in FIG. 6A).

FIG. 8B illustrates a transfer or remittance from one digital wallet to any other remotely located digital wallets. As shown in FIG. 8B, a digital wallet 100 of the user wants to transfer or remit money to a digital wallet 100 a (hard wallet) or a digital wallet (soft) 102 located at a remote location. In such situation, the digital wallet 100 communicates with a transaction terminal 300 via a wireless medium 400, and provides the transaction terminal 300 with the transaction request sent by the digital wallet 100. The sender transaction terminal 300 thereafter relays the transaction request to World Wide Web (WWW), as shown by arrow labeled 200. In case the transaction terminal 300 does not have network access then it can store the details of the transfer instructions and provide them to the server 800 (shown in FIG. 5) when it is connected with World Wide Web (WWW).

Thereafter, the request is received by the server 800, which relays the request for the digital wallet 100a, as shown by arrow labeled 200a to the receiver transaction terminal 300a. In case the transaction terminal 300a does not have network access, then it can receive the transfer instruction whenever it gets connected to the World Wide Web (WWW). The receiver transaction terminal 300a thereafter stores the information till transacting with the intended digital wallet 100a (hard wallet) or digital wallet 102 (soft) connects with the transaction terminal 300a over a communication medium 400 for completing the transaction request.

FIG. 8C illustrates the scenario of effecting a transfer or remittance from one digital wallet 100 (hard wallet) to another software Based Digital Wallet 102 that is directly connected to World Wide Web (WWW). In this case, the software based digital wallet 102 may directly receive the transfer without the need of any intermediate transaction terminal (shown in FIG. 8B).

In this case, the digital wallet 100 that wants to remit money to a remote user (software digital wallet 102), sends a transaction request to a transaction terminal 300 over a wireless communication medium 400. The transaction terminal 300 thereafter accepts the transaction request and passes the transaction request through the World Wide Web (WWW) for further processing and reconciliation with the server 800 (not shown) via a WAN interface 200. In case the transaction terminal 300 does not have network access then the transaction terminal 300 may be adapted to store the details of the transaction request and provide the transaction request to the server 800 (not shown) whenever it gets connected to the WAN interface 200 (not shown).

FIG. 8D illustrates the scenario of affecting a transfer or remittance from first software based digital wallet 102 to second software based digital wallet 102a when both the wallets are directly connected to the server 800 via a World Wide Web (WWW) or other means. In this scenario, first and second software based digital wallets 102, 102a are remotely located at far away locations.

FIG. 8E illustrates a scenario of affecting a transfer or remittance from one software based digital wallet 102 to another entity that acts as the beneficiary software based digital wallet 900. This second entity 900 could, for example be a beneficiary account located with the server 800 (not shown). This is useful in scenarios like payment of utility bills, “Cash on Delivery” payment when buying goods online, and the like.

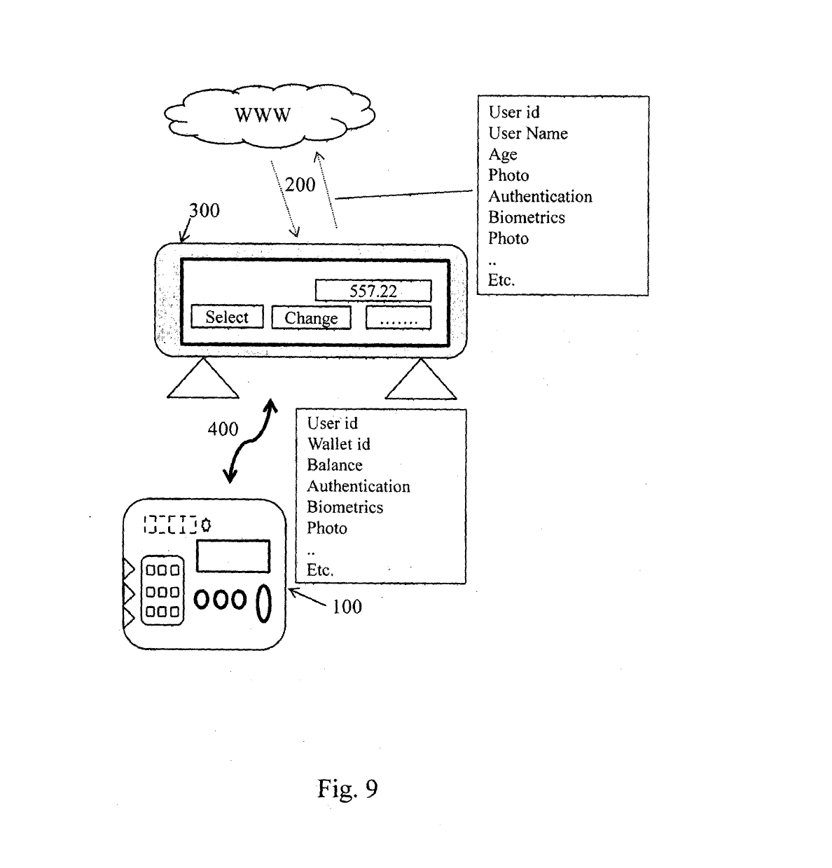

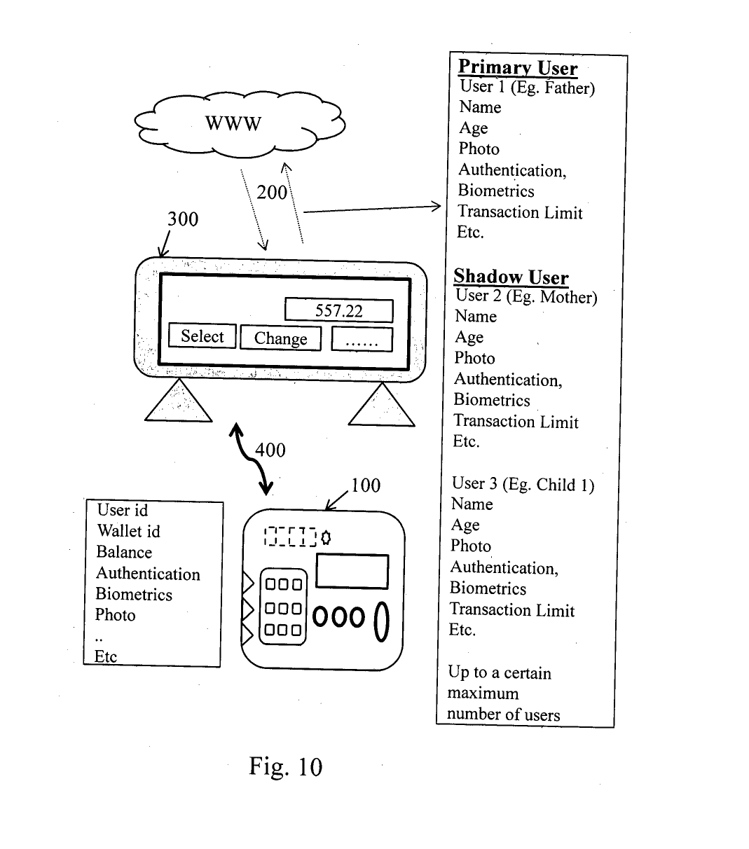

FIGS. 9-10 illustrate an operational method between a digital wallet 100 and a transaction terminal 300 in a scenario where a user brings the digital wallet 100 in close proximity to the transaction terminal 300 to affect a transaction over a communication medium 400. In such scenario, the transaction terminal 300 fetches information about the user from the server database 801 (not shown) hosted over WAN interface 200, such as a cloud based network.

More specifically, as shown in FIG. 9, when the digital wallet 100 comes in close proximity with the transaction terminal 300, the digital wallet 100 provides certain financial and personal information about wallet ID, Balance, authentication information, photo, biometrics information and other relevant parameters to the transaction terminal 300. Thereafter, the information is received by the transaction terminal 300 which simultaneously or later sends a query to the server database 801 (not shown). The server 800 (not shown) on receipt of the query, responds with addition financial and personal information, such as user's name, age, photo and biometrics information.

The information so responded is thereafter stored in the transaction terminal 300 for future reference, thereby saving time when next time the digital wallet 100 comes in contact with the transaction terminal 300. Since this information is now stored in the transaction terminal 300, the transaction terminal 300 does not need to be online, whenever the same wallet comes in proximity of the transaction terminal 300 the next time. This is useful in the scenario shown in FIG. 8 where even if the transaction terminal 300 is offline, it has information about the user's name, age, photo, biometrics and other such financial and personal information.

Further, FIG. 10 illustrates a situation where one single digital wallet supports multiple user profiles. In such a case, the users may either share some common authentication information (like the Personal Identification Number) and may have some other unique authentication information (such as Biometrics). When the digital wallet 100 queries the server 800 (not shown) for the user information, the transaction terminal 300 will receive information about all the user profiles associated with the digital wallet 100. Out of the users, one of the users could be the primary user and the other users could be shadow or add-on users.

Further, all the users may share the same balance; however, there might be a different transaction limit for each of the users. For example if the digital wallet 100 is shared by various family members, all of the family members will be able to share the balance in the wallet, however, the children may have a lower transaction limit as compared to the parents. This will allow different users to have different limits over the same digital wallet 100. Another use case could be a set of roommates living together and using a common digital wallet for all household expenses. So any of the roommates may use the digital wallet for grocery or utilities expenses instead of each person having a separate digital wallet.

In one embodiment, the communication medium, as mentioned in figures, such as communication medium 400, is a Wireless Medium over which the communication takes place. Suitable examples of the Wireless Medium include, but are not limited to, Bluetooth, Infrared and Radio Frequency Identification (RFID), Near Field Communication (NFC), WiFi, ANT, or ZigBee, and other radio links. However, such examples of the communication medium should not be construed as a limitation to the present invention. Accordingly, any other communication mediums, whether wired or wireless may be employed in various embodiments of the present invention.

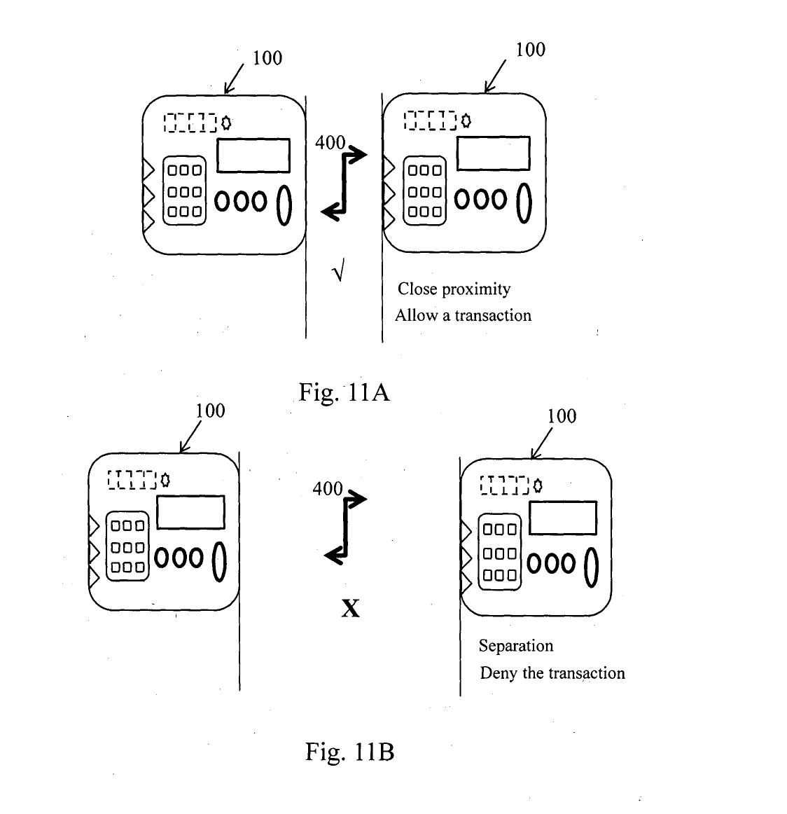

Referring to FIGS. 11A and 11B, the configuration proximity aspect of various digital wallets, such as digital wallets 100, is illustrated. It should be noted that the communication between two digital wallets or a digital wallet and a transaction terminal 300 would be successful only if they are brought at a distance which is nearer than a pre-defined distance. Otherwise, the communication would fail. Depending on the security settings and end use, this proximity distance requirement may be configured. For example for a financial transaction the proximity requirement may be configured to be less than a few centimeters while for a transaction at an amusement park or theatre entry gate, it may be configured to higher distances, such as around a meter.

There is shown in FIG. 11A a successful transaction between the digital wallets 100. On the other hand, there is shown an unsuccessful transaction between the digital wallets 100 in FIG. 11B, when separation is more than the defined proximity requirement.

FIG. 12A illustrates a simplistic flow chart of how a payment transaction may happen between the digital wallet 100 and the transaction terminal 300, according to various embodiments of the present invention. As shown in FIG. 12A, the method starts at step 20. Thereafter, the user switches on or turns on the transaction terminal, at step 22. At step 24, the transaction terminal scans the digital wallets around its vicinity and displays the list of devices or digital wallet found. The list of devices or digital wallets may be displayed in an increasing order of distance with the account holder name of the digital wallet, or any other order.

At step 28, an operator of the transaction terminal selects the relevant digital wallet based on the information as in step 26. Thereafter, the operator enters an amount of the transaction. The received request is generated and sent to the digital wallet at step 30. Thereafter, for completion of electronic transaction, the confirmation of paid/declined is displayed on the transaction terminal. The transaction terminal may update the balance of the transaction terminal and the digital wallet at the server, at step 142 if it is connected to the network. The method then stops at step 36.

FIG. 12B illustrates a detailed flow chart of how a payment transaction may happen between the digital wallet, such as a digital wallet, and a transaction terminal, shown as method 1000. Steps like error checking, low balance scenario, transaction and communication failures etc. are not shown to ease understanding of the sequence. As shown in FIG. 12B, the method starts at step 110. Thereafter, the user switches on or turns on the digital wallet, at step 112. In one embodiment, after turning on operation of the digital wallet, the user first authenticates himself/herself to the digital wallet. This may be done by entering a PIN number or using biometrics. Once the authentication is successful, balance display to the user occurs. In another embodiment, authentication may be as part of step 130. At step 114, the transaction terminal scans the digital wallets around its vicinity. Meanwhile, the digital wallet advertises itself at step 116. Thereafter, the method moves to step 118.

At step 118, the transaction terminal shows a list of digital wallets that are found near to the transaction terminal during scan at step 114. The list of digital wallets is sorted in increasing order of their distance. Further, the list also shows the name of the digital wallet holder. If the user is in the home location, and if the transaction terminal is online, then the transaction terminal may fetch and display additional information like user's age, photo, etc. may be shown. The transaction terminal may also cache the user's information so that it need not be online when the same user comes in vicinity of the transaction terminal the next time.

At step 120, an operator of the transaction terminal selects the relevant digital wallet based on the information as in step 116. In one embodiment the selection could be by way of pairing using NFC. Thereafter, the operator enters an amount of the transaction. The received request is generated and sent to the digital wallet at step 122, and the same amount is displayed to the user by the digital wallet textually and through audio output, at step 124.

The user then approves or declines the transaction at step 128, and a handshake happens between the digital wallet and the transaction terminal. The handshake involves debiting the said amount from the digital wallet and crediting the said amount at the transaction terminal side at steps 130 and 132. All this is carried out in a secure environment by using appropriate security mechanisms using a secure element. Besides this, the transaction is carried out atomically so that if, due to any reason the transaction is not successfully completed, (For example if the transaction terminal or wallet move out of the wireless proximity or the battery goes down), the transaction is voided and the original balance is maintained.

Once the transaction is successful, an alarm (audio and/or visual/haptic) could be sounded to the operator and the user confirming whether the transaction has been approved or declined, at steps 134 and 136. Thereafter, the balance might be updated at step 138 on the digital wallet, and the user may then switch off the device at 140. If the user does not switch off the device, a timer may be used to automatically switch off the device after certain duration. On the other hand, the transaction terminal may update the balance of the transaction terminal and the digital wallet at the server, at step 142 if it is connected to the network. In case it is not connected to the network, it stores the transaction and passes it on to the server at a later time when it gets connected to the network and has access to the server. The method then stops at step 144.

FIG. 13A illustrates a flow chart of how a payment transaction may happen between two digital wallets. The method starts at step 40. Thereafter, the user switches on or turns/on the digital wallet. In one embodiment, the user first authenticates himself/herself to the digital wallet, at step 42. If the authentication is successful, the wallets show the balance to the respective users. Thereafter, at the receiver wallet, the receiver selects the amount to be transacted, at step 44. At step 46, the wallet scans for nearby digital wallets. Thereafter, in step 48 the digital wallets send/receives the transaction request to the desired digital wallet for electronic transaction. In another embodiment authentication is done before step 48. After successful transaction, the balance is displayed on digital wallet screen, at step 50. The digital wallet may update the balance at the server, at step 52 if it is connected to the server via the internet by third party device. The method then stops at step 54.

FIG. 13B illustrates a detailed flow chart of how a payment transaction may happen between two digital wallets (receiver wallet and payer wallet). Steps like error checking, low balance scenario, transaction and communication failures etc. are not shown to ease understanding of the sequence. The method starts at step 160. Thereafter, the receiver and payer wallets are switched on, at steps 162 and 164. At the time of switching on, in one embodiment, both the wallets perform and authentication similar to the one carried out in step 112. If the authentication is successful, the wallets show the balance to the respective users. In another embodiment, authentication is done as a part of step 178. Thereafter, at the receiver wallet, the receiver selects the amount to be transacted, at step 166. Once the amount is input by the user, the wallet may give an audio or visual feedback to the user to confirm the amount. At step 168, the receiver wallet scans for nearby digital wallets. At the same time, at step 170, the payer wallet advertises, and the receiver wallet registers the payer wallet. Thereafter, the receiver wallet sends the transaction request to the payer wallet at step 172. The payer wallet receives the request, and the transaction amount is displayed to the payer, at step 174. At step 176, the payer either accepts or rejects the request, and thereafter there is a handshake between the receiver and the payer wallet, at step 178, in which the payer wallet is debited and the receiver wallet is credited with the said transaction amount. As in step 130 and 132, this transaction is carried out in a secure environment. The atomicity of the transaction is maintained so that, if the transaction fails to complete due to any reason, it is entirely voided.

At step 180, the amount credited and debited is displayed on the respective wallets, and at step 182, the balance is displayed to the receiver and the payer. The payer and receiver wallets are thereafter switched off (manually or automatically) at step 184 and the method stops execution at step 186.

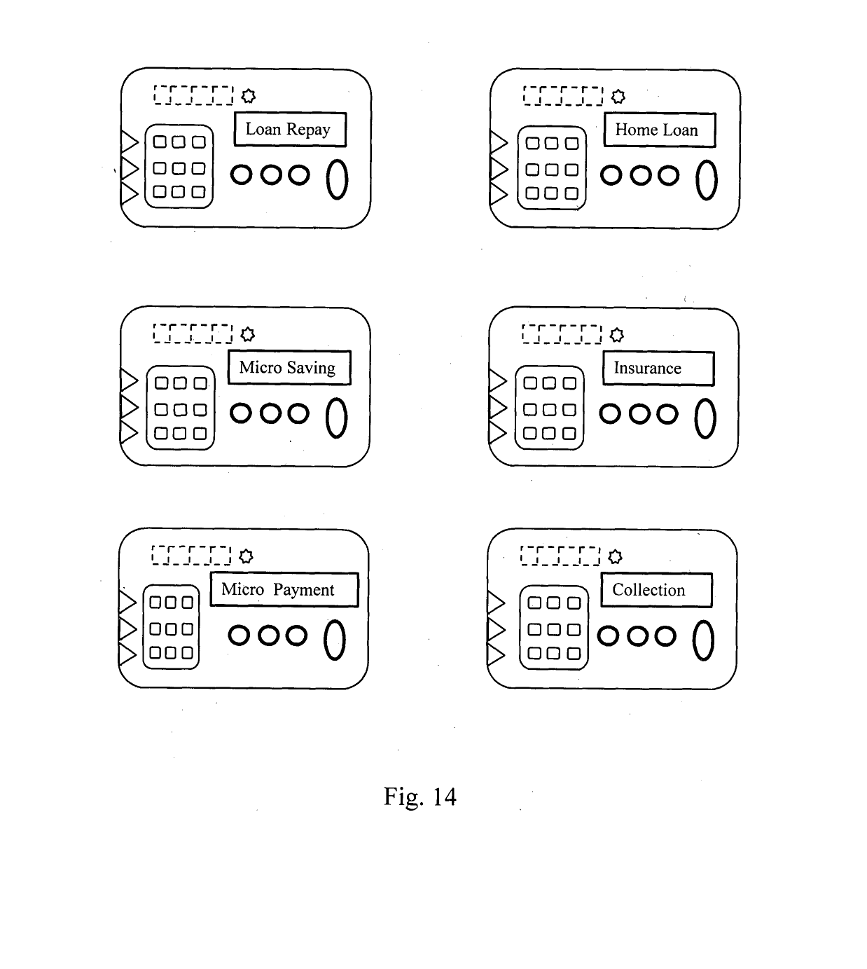

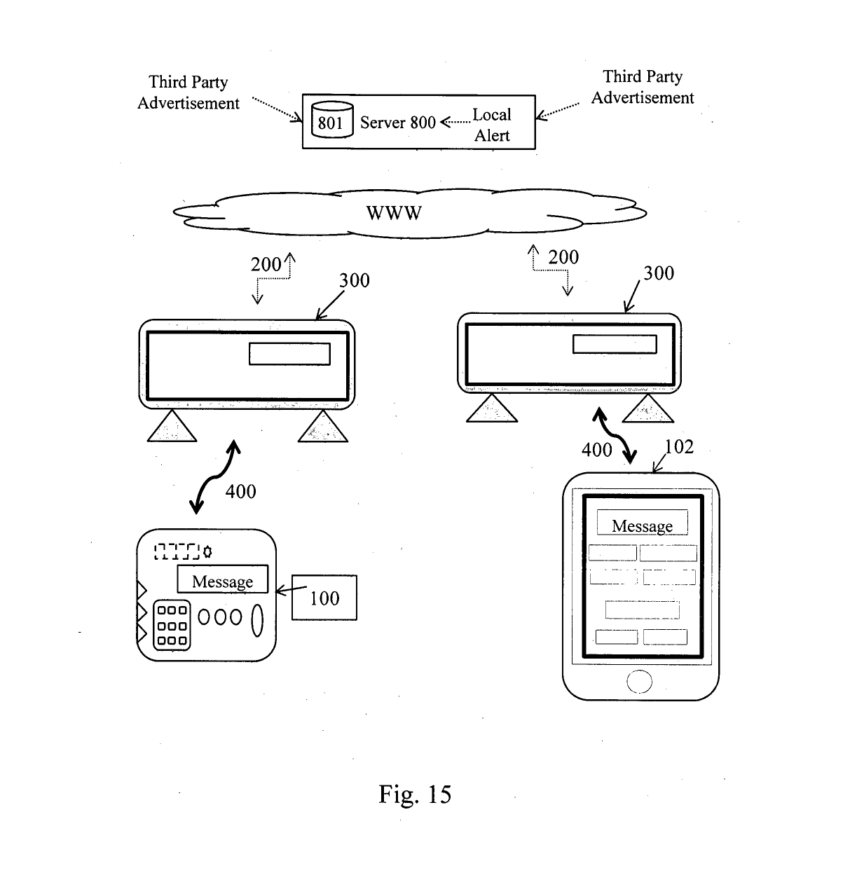

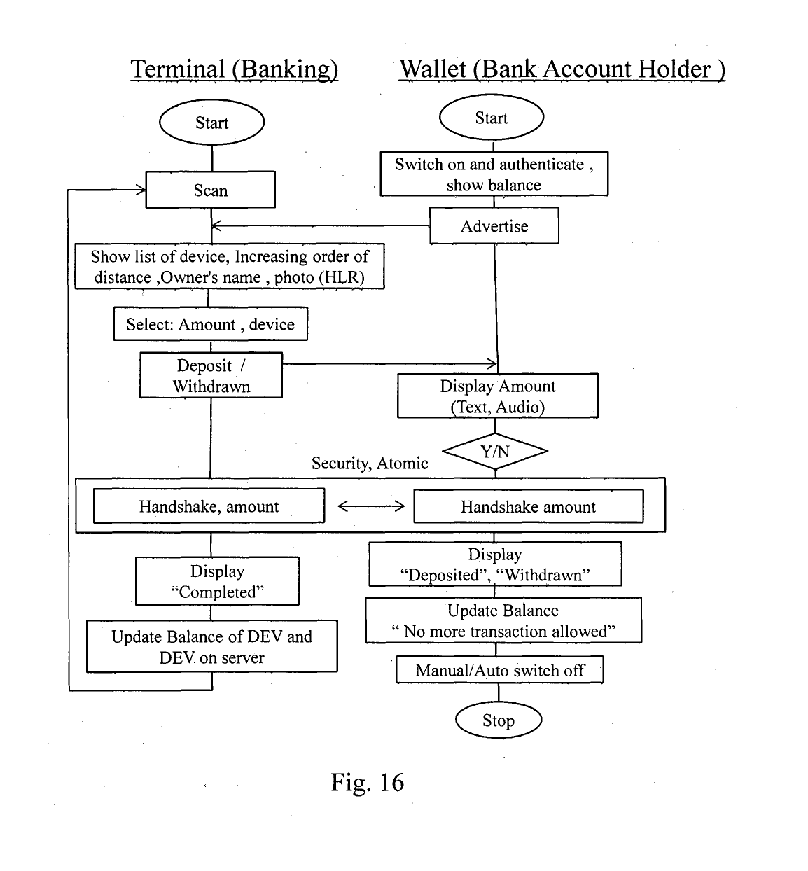

Referring to FIG. 14 and FIG. 15, there is illustrated a scenario where a targeted advertisement or 3rd party advertisement is pushed on the hardware digital wallet 100 or software digital wallet 102 through the server 800 by using the WAN interface 200 and wireless medium 400. In this embodiment, the server 800 is further configured as a ‘publishing platform’ for a plurality of external mobile advertisement platform providers or 3rd party advertisers.

In another aspect of the present invention, the server 800 further includes local alert filter platform that receives advertisements from the mobile advertisement platform providers (not shown). The local alert filter platform communicates and exchanges information with the server 800 to determine whether to serve an advertisement to a particular POS or transaction terminal 300 via communication 200, which advertisements to serve and at what time to serve the advertisements to that POS or transaction terminal 300. The POS or transaction terminal 300 is further adapted to transfer the 3rd part advertisement to those digital wallets which are in communication with the POS or transaction terminal 300.

In another aspect of the present invention, the transaction terminal or POS 300 is adapted to receive 3rd party advertisements from the server 800 via communication 200. Further, the transaction terminal 300 is adapted to push the 3rd party advertisements to the digital wallets 100 or to the software digital wallet 102 whenever both the software digital wallet 102 and hardware digital wallet 100 gets communicably coupled with the transaction terminal or POS 300 via communication 400.

In another aspect to the present invention, the digital wallets are adapted to share the 3^{rd} party advertisement with other digital wallets via communication 400.

In another aspect, the present invention provides a computer program product with executable instructions which, when executed by one or more processors. The computer program product enables a digital wallet and selects one of the one or more of the software or hardware based digital wallets to transact with. Thereafter, the computer program product sends an electronic transaction request to the selected digital wallet via a communication means. The computer program product further includes carrying the electronic transaction in an offline manner, wherein the electronic transaction gets synchronized with the server when one of the one or more software or hardware digital wallets gets communicably coupled to a wide area network.

The set of instructions may include various commands that instruct the processing machine to perform specific tasks such as the steps that constitute the method of the disclosed teachings. The set of instructions may be in the form of a software program. The software may be in various forms such as system software or application software. Further, the software might be in the form of a collection of separate programs, a program module with a larger program or a portion of a program module. The software might also include modular programming in the form of object-oriented programming. The software program or programs may be provided as a computer program product, such as in the form of a computer readable medium with the program or programs containing the set of instructions embodied therein. The processing of input data by the processing machine may be in response to user commands or in response to the results of previous processing or in response to a request made by another processing machine.

The present invention provides systems and methods for implementing a wireless digital wallet. More specifically, the present invention provides for an electronic version of a wallet (also interchangeably referred to as “digital wallet”) to replace cash carried by users in their wallets. Accordingly, the digital wallet allows users to imitate various transactions that are usually done with physical currency notes. Suitable examples of such activities may include but are not limited to withdrawing cash from a bank account, storing the cash, taking out cash from the wallet to pay to a vendor, paying cash to another user, depositing cash from the wallet to the bank account, transferring cash to another user, and other similar activities. The present invention further allows carrying out transactions without the need to be connected to a WAN.

The present invention has various advantages. The invention attempts to provide flexibility and convenience of a cash wallet in form of a digital wallet. On the other hand, the present invention does not allow any compromises on security aspects, thereby making transactions carried out by the digital wallets as highly safe, accurate and secure. For example, when compared with open nature of a physical wallet, the authentication mechanisms in the digital wallet provide a highly restrictive protection than physical cash.

The digital wallets of the present invention use ultra-low power wireless technologies for data transfer, which ensures that the wallet can be used for extended periods, in some cases several years, without the need of recharging or replacing batteries. Further, the digital wallets of the present invention assure that once two users are carrying out transactions, they are doing so in close proximity, thereby mimicking a typical cash or card transaction.

The present invention further precludes the need of physically touching or tapping the two devices to effect a transaction but still provides a similar level of security by placing requirements for the devices to be in close vicinity (like a few centimeters) in order to effect transactions. Accordingly, even though the users may not need to touch the digital wallets to Point of Sale (POS) or transaction terminal, they still need to bring it within a few centimeters of the transaction terminal for carrying out transactions. This requirement implies an explicit authentication by requiring physical presence of the digital wallet holder and eliminates the risk of MITM (Man-In-The-Middle) attacks.

The present invention further has additional level of security by keeping the wireless device in off mode most of the time. The digital wallets are switched on only when a transaction is to be done and then the digital wallet may automatically be switched off. Even while the digital wallet is switched on, the digital wallet remains visible only for a very brief period of time. Such action significantly reduces the time span that is available for any malware to attack the digital wallet, thereby significantly enhancing the security aspects of the digital wallet. Besides security, the digital wallet works on mechanism which helps in making the device power efficient and reduces the need of regular recharging or replacement of batteries.

The present invention further allows multi-level security by using a combination of one or more of the following: unique user ID, unique device ID, PIN Code entry and biometrics, for corroboration and authentication. Biometric information, such as finger prints, facial, retina scans, voice, is always unique to each individual. These features preclude the possibility in which users suffer from problems, such as forgetting PIN number, or a hit-and-trial attack on the digital wallet by entering possible PIN numbers. The invention allows for use of one or more biometric validations to create a product range with varied levels of security.

Moreover, the present invention, in one of its embodiment, adds an optional iconic Input/Output for users who have limited literacy or are visually challenged. For such users, the digital wallet uses icons to display currency. More specifically, the digital wallet uses icons of currency of 1, 5, 20, 50 and 100, and the like. Such icons make the digital wallets easy to use by such users. For example, if a user has to enter an amount of 140, the user is required to press the 100 button provided on the digital wallet once, followed by pressing the 20 button two times. In one embodiment, the buttons may have braille markings, thereby allowing visually impaired users to enter amounts conveniently. The digital wallet may additionally play an audio feedback (such as reciting amount that was entered in the local dialect) to indicate and validate the amount entered.

Moreover, the digital wallet of the present invention is highly secure. It will be appreciated by persons skilled in the art that as with any financial transaction, security of the transaction is of utmost importance. The present invention provides for several security measures to ensure that the transactions are carried on in a secure manner. In the unfortunate event of the digital wallet being lost, the present invention provides a mechanism to lock and black-list the digital wallet so that no further transactions can be done with that particular digital wallet. In such scenario the remaining money in that digital wallet may be safely transferred to another digital wallet once the digital wallet is locked. This provides a degree of protection not accorded by traditional cards or wallets.

The digital wallet further includes storage capability to keep a record of the cash balance within the digital wallet, and other storage features. This removes the need of the digital wallet always being connected to the WAN to get information about the balance. This assists in several ways, including keeping the cost of digital wallet low, reducing traffic on the WAN, recurring cost in terms of any Internet usage fee and according low power consumption.

Moreover, in various embodiments, the digital wallet uses the transaction terminal as a gateway to synchronize the balance with the server and when needed. This precludes the need of direct connectivity of the digital wallets with the financial institution. In such a case, the digital wallet communicates with the transaction terminal whenever it comes within the communication field of the transaction terminal.

In another embodiment, a hardware based digital wallet is configured to interact with software based digital wallet which in-turn connects to the WAN for conciliation and reconciliation. This allows synchronization between the hardware based wallet and the software based wallet so that the balance of both the hardware based digital wallet and software based digital wallet may be synchronized with the financial institution.

In another embodiment, a POS or transaction terminal 300 and digital wallet 100 are adapted to facilitate electronic transactions simultaneously with multiple digital wallets, wherein different wallets are in different stages of transaction. For example, the transaction terminal 300 and the digital wallet 100 may be configured in a way such that they can transact with each other when the digital wallets are in different stages of transaction, including but not limited to, power on, discovery, connection, encryption/decryption, transaction and completion.

In another embodiment, a hardware based digital wallet is configured to interact with software or personal computing device/tablet for backing up the information stored in the wallet. This precludes the chances of losing critical data if the wallet gets lost or gets stolen.

In yet another embodiment, two software based digital wallets can interact wirelessly and effect a payment or transfer of funds. This is especially useful in economies where cash payment on delivery is preferred means of payment. In one variation the second software based digital wallet can reside as an instance in the backend platform.

Moreover, the digital wallet may have a built-in alert system to provide information about any transactions that are happening on the Bank Account(s) that are linked with the digital wallet. For example, an LED on the digital wallet may turn green to signify that a credit has been made to the linked bank account. This may be the case, for example, when a government subsidy has been deposited into the bank account. Similarly, the LED may turn red when a debit has been made from the linked bank account. For example a loan repayment may be automatically debited on the due date.

Moreover, some limits may be set in the digital wallet in order to protect the users from scenarios like excessive withdrawal, deposit or misuse by someone else. Some examples of these limits are:
Number of transactions that can be done per day (or any other duration).
Maximum amount per transaction.
Total cumulative amount of all transactions that can be done per day (or any other duration).
Total value of offline transaction.
Total number of offline transaction.

Moreover, the digital wallet may not only be used for currency but for other applications as well. Some of the other possible applications are:
For storing frequent flyer miles, loyalty points for stores, reward cards, gift cards, etc. In such embodiments, the wallet may store information about the user, number of reward points or miles accumulated, and the like.
For entry into amusement parks, theatres, concerts etc. In such embodiments, the wallet may store information about the user, number of credits, validity date, and the like.
For saving government issued ID's like passport, driving license etc.
For saving location information, geographical coordinates of places traversed, etc (For example for a vehicle tolling system).

Moreover, the digital wallet may not only be used for currency but for other applications as well.

The present invention further allows the storage of multiple currency types; Rupee (INR), Dollar (USD), Euro etc. in one digital wallet.

In another embodiment, the Point of Sale Terminal may be enabled with a positioning mechanism like GPS (Global Positioning System) which can provide the location of the Point of Sale Terminal. The transactions with the Digital Wallet can then be “location stamped” in order to find out the geographical area where the transaction was carried out by the digital wallet. This can be useful in finding out useful information like buying patterns of users, number of users in a given geographical area, location of a stolen digital wallet, and the like.

A location enabled wallet will also have the ability to switch payment into the preferred currency at that location. So if a wallet is in India it will enable INR as the prime means of payment and will automatically change to Euro when in Europe.

Moreover, the Digital Wallet may be used for collecting useful financial and personal user information. This includes information like:
Buying patterns of the user,
Geographical locations where the user generally carries out the transactions.
   The information can be processed using data analysis to generate credit history and rating of the user.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, and to thereby enable others skilled in the art to best utilize the present invention and various embodiments with various modifications as are suited to the particular use contemplated. It is understood that various omissions and substitutions of equivalents are contemplated as circumstances may suggest or render expedient, but such omissions and substitutions are intended to cover the application or implementation without departing from the spirit or scope of the present invention.

### REFERENCE NUMERALS

100 Digital Wallet device
102 Software Based Digital Wallet
110 Processor
112 Communication interface
114 Memory
114a Transaction module
114b Applet module
120 Input Unit
122 Authentication module
122a Biometric Input unit
112 a Trans-receiver
124 Wireless antenna
126 Secure element
118 Audio/visual unit
118a Display
118b Audio Input
118c Audio Output
118d Visual alert device
116 Power module
116a Powering unit
116b Auxiliary powering unit
116c Power controller
200 Wide Area Network (WAN)
300 Transaction terminal
310 Legacy POS terminal
320 Adaptor module
400 Communication medium/Low power short range communication
800 Servers
801 Database
810 System platform

What is claimed is:

1. A digital wallet for carrying electronic transactions, the digital wallet comprising:
a communication interface adapted to send and receive data;
processor; and
a memory comprising a transaction module adapted to,
carry an electronic transaction in an offline manner, and
synchronize the carried electronic transaction when the digital wallet gets communicably coupled to a wide area network.

2. The digital wallet as claimed in claim 1 further comprising an authentication module coupled to the transaction module, the authentication module is adapted to authenticate a user of the digital wallet.

3. The digital wallet as claimed in claim 2, wherein the authentication module is adapted to authenticate the user by biometric authentication.

4. The digital wallet as claimed in any of the claim 2 or 3, wherein the biometric authentication includes at least one of finger, retina, face and voice authentication, or a combination thereof.

5. The digital wallet as claimed in claim 1, wherein the transaction module is further adapted to validate the carried electronic transaction.

6. The digital wallet as claimed in any of the preceding claims 1-5 further comprising an audio/visual unit capable of notifying an audio and/or visual feedback of the carried electronic transaction to a user of the digital wallet.

7. The digital wallet as claimed in any of the preceding claims 1-6 further comprising a power module comprising a powering unit adapted to power the digital wallet.

8. The digital wallet as claimed in claim 7, wherein the powering unit harvests energy from the environment.

9. The digital wallet as claimed in any of the claims 7-8, wherein the power module comprises a power controller coupled to the powering unit, the power controller adapted to cease power of the digital wallet in one or more predefined situations.

10. The digital wallet as claimed in any of the preceding claims 1-9 further comprising an input unit adapted to receive instructions from a user of the digital wallet.

11. The digital wallet as claimed in claim 1, wherein the transaction module is downloadable in the memory of the digital wallet.

12. The digital wallet as claimed in any of the preceding claims 1-11, wherein the communication is via low power short range communication.

13. The digital wallet as claimed in claim 12, wherein the low power short range communication is at least one of Bluetooth, Infrared and Radio Frequency Identification (RFID), Near Field Communication (NFC), Wi-Fi, ANT, or ZigBee.

14. The wallet as claimed in claim 1, wherein the memory comprises a storage means for storing various currency types, Unique Identification (UIADI) including) Biometrics, Social Security Number (SSN), Driver's License (DL) Number, loyalty points information, frequent flyer miles information, and club membership information, for one or more users using the digital wallet.

15. The wallet as claimed in claim 1 further comprises a secure element capable of encrypting and decrypting the electronic transactions carried between various users.

16. A system for implementing electronic transactions between various users, the system comprising:
a server for storing financial and personal information of the users;
at least one transaction terminal capable of connecting to the server via a wide area network; and
one or more digital wallets capable of communicating with each other, each of the one or more digital wallets comprising:
a communication interface adapted to send and receive data,
processor, and
a memory comprising a transaction module adapted to,
carry an electronic transaction in an offline manner, and
synchronize the carried electronic transaction when the digital wallet gets communicably coupled to the at least one transaction terminal.

17. The system as claimed in claim 16, wherein the server comprises a database for storing the financial and personal information of the users.

18. The system as claimed in claim 17, wherein the personal information comprises biometric information of the users.

19. The system as claimed in claim 16, wherein the at least one transaction terminal is a kiosk, a point of sale (POS), a transaction terminal, an automated teller machine (ATM) or a merchant machine.

20. The system as claimed in claim 16, wherein the each of the one or more digital wallets further comprises an authentication module coupled to the transaction module, the authentication module adapted to authenticate a user of the digital wallet.

21. The system as claimed in claim 16, wherein the authentication module is adapted to authenticate the user by biometric authentication.

22. The system as claimed in claim 16, wherein the transaction module is further adapted to validate the carried electronic transaction.

23. The system as claimed in claim 16, wherein the transaction module is downloadable in the memory of the digital wallet.

24. The system as claimed in claim 16, wherein the one or more digital wallets communicate with each other via low power short range communication.

25. The system as claimed in claim 24, wherein the low power short range communication is at least one of Bluetooth, Infrared and Radio Frequency Identification (RFID), Near Field Communication (NFC), WiFi, ANT, or ZigBee.

26. The system as claimed in claim 16, wherein the synchronization between the one or more digital wallets and the at least one terminal comprises conciliation and reconciliation of electronic transactions carried within and between the one or more digital wallets.

27. The system as claimed in claim 16, wherein the server comprises loyalty points, frequent flyer miles, and club membership information of the users.

28. The system as claimed in claim 16, wherein each of one or more digital wallets is adapted to be used by multiple users.

29. A system for implementing electronic transactions between various users, the system comprising:
a server for storing financial and personal information of the users; and
one or more digital wallets capable of communicating with each other, each of the one or more digital wallets comprising,
a communication interface adapted to send and receive data,
processor, and
a memory comprising a transaction module adapted to,
carry an electronic transaction in an offline manner, and
synchronize the carried electronic transaction when at least one of the one or more digital wallets gets communicably coupled to the server via a wide area network.

30. The system as claimed in claim 29, wherein the server comprises a database for storing the financial and personal information of the users.

31. The system as claimed in claim 30, wherein the personal information comprises biometric information of the users.

32. The system as claimed in claim 29, wherein the each of the one or more digital wallets further comprises an authentication module coupled to the transaction module, the authentication module adapted to authenticate a user of the digital wallet.

33. The system as claimed in claim 29, wherein the authentication module is adapted to authenticate the user by biometric authentication.

34. The system as claimed in claim 29, wherein the transaction module is further adapted to validate the carried electronic transaction.

35. The system as claimed in claim 29, wherein the transaction module is downloadable in the memory of the digital wallet.

36. The system as claimed in claim 29, wherein the synchronization between the one or more digital wallets with the server comprises conciliation and reconciliation of electronic transactions carried within and between the one or more digital wallets with the server.

37. A method for implementing electronic transactions between various users, each of the user carrying a digital wallet as claimed in any of the preceding claims 1-15, the method comprising:
enabling a first digital wallet;
selecting one of the one or more digital wallets to transact with;
sending an electronic transaction request to the selected digital wallet from the first digital wallet via a communication means; and
carrying the electronic transaction between the first digital wallet and the selected digital wallet in an offline manner,
wherein the electronic transaction gets synchronized with a server when either of the first digital wallet or the selected digital wallet gets communicably coupled to the wide area network.

38. The method as claimed in claim 37 wherein the selection of the one or more digital wallets is via low power short range communication.

39. The method as claimed in claim 37, wherein the first digital wallet and the selected digital wallet communicate with each other via low power short range communication.

40. The method as claimed in any of the claim 38 or 39, wherein the low power short range communication is Bluetooth, Infrared and Radio Frequency Identification (RFID), Near Field Communication (NFC), WiFi, ANT, or ZigBee.

41. The method as claimed in claim 37 further comprising authenticating at least one of the first digital wallet and the selected digital wallet.

42. The method as claimed in claim 41, wherein authentication comprises biometric authentication.

43. The method as claimed in any of the preceding claims 37-42, wherein carrying the electronic transaction further comprises validating the electronic transaction between the first digital wallet and the selected digital wallet.

44. The method as claimed in any of the preceding claims 37-43, wherein carrying the electronic transaction further comprises sending and receiving of credit and debit information between the first digital wallet and the selected digital wallet.

45. The method as claimed in claim 37, wherein the synchronization between either of the first digital wallet or the selected digital wallet and the server comprises conciliation and reconciliation of the electronic transaction between the first digital wallet and the selected digital wallet.

46. The method as claimed in any of the preceding claims 37-45 further comprising securing the electronic transactions carried between various users.

47. The method as claimed in claim 46, wherein securing the electronic transactions comprises encrypting and decrypting the carried electronic transactions.

48. A method for implementing electronic transaction between various users, each of the user carrying a digital wallet as claimed in any of the preceding claims 1-15, the method comprising:
enabling at least one transaction terminal;
selecting one of the one or more digital wallets; the selection being done by the at least one transaction terminal;
sending an electronic transaction to the selected digital wallet from the at least one transaction terminal via a communication means; and
carrying the electronic transaction between the at least one transaction terminal and the selected digital wallet in an offline manner,
wherein the electronic transaction gets synchronized with a server when either of the selected digital wallet or the at least one transaction terminal gets communicably coupled to a wide area network.

49. The method as claimed in claim 48, wherein the one or more digital wallets and the at least one transaction terminal communicate with each other via low power short range communication.

50. The method as claimed in claim 49, wherein the low power short range communication is Bluetooth, Infrared and Radio Frequency Identification (RFID), Near Field Communication (NFC), WiFi, ANT, or ZigBee.

51. The method as claimed in any of the preceding claims 48-50 further comprising authenticating at least one of the one or more digital wallets.

52. The method as claimed in claim 51, wherein the authentication comprises biometric authentication.

53. The method as claimed in any of the preceding claims 48-52, wherein carrying the electronic transaction further comprises validating the transaction between the selected digital wallet and the transaction terminal.

54. The method as claimed in any of the preceding claims 48-53, wherein carrying the electronic transaction further comprises sending and receiving of credit and debit information between the selected digital wallet and the transaction terminal.

55. The method as claimed in claim 48, wherein the synchronization between at least one of the one or more digital wallets and the server comprises conciliation and reconciliation of electronic transactions between at least one the one or more digital wallets and the transaction terminal.

56. The method as claimed in any of the preceding claims 48-55 further comprising securing the electronic transactions carried between various users.

57. A computer program product comprising executable instructions which, when executed by one or more processors, cause the one or more processors to carry out the steps of:
enabling a digital wallet;
select one of the one or more of the digital wallets to transact with;
send an electronic transaction request to the selected digital wallet via a communication means; and
carry the electronic transaction in an offline manner,
wherein the electronic transaction gets synchronized with a server when one of the one or more digital wallets gets communicably coupled to a wide area network.

58. The computer program product as claimed in claim 57 further comprising the step of authenticating the one or more digital wallets.

59. The computer program product as claimed in claim 58, wherein the authentication comprises biometric authentication.

60. The computer program product as claimed in any of the preceding claims 57-59, wherein the step of carrying the electronic transaction further comprises the step of validating the electronic transaction.

61. The computer program product as claimed in any of the preceding claims 57-61, wherein the step of carrying the electronic transaction further comprises the step of sending and receiving of credit and debit information.

62. The computer program product as claimed in claim 57, wherein the synchronization between the one or more digital wallets and the server comprises conciliation and reconciliation of the electronic transaction.

63. The computer program product as claimed in any of the preceding claims 57-62 further comprising executable instructions which, when executed by one or more processors, cause the one or more processors to secure the electronic transactions carried between various users.
